(19) United States
(12) Patent Application Publication
(10) Pub. No.: US 2020/0252579 A1
(43) Pub. Date: Aug. 6, 2020

(54) ELECTRONIC APPARATUS RECORDING MEDIUM, AND DISPLAY METHOD

(71) Applicant: KYOCERA Corporation, Kyoto-shi, Kyoto (JP)

(72) Inventors: Yujiro FUKUI, Yokohama-shi, Kanagawa (JP); Keisuke NAGATA, Kobe-shi, Hyogo (JP)

(21) Appl. No.: 15/999,812

(22) PCT Filed: Feb. 8, 2017
(86) PCT No.: PCT/JP2017/004572

§ 371 Date: Aug. 20, 2018

(30) Foreign Application Priority Data
Feb. 24, 2016 (JP) 2016-032976

(51) Int. Cl. H04N 5/93; G06F 3/0485; G06F 3/0484; G11B 27/34

(52) U.S. Cl. CPC H04N 5/9305; G06F 3/04855; G06F 3/0488; G11B 27/34; G06F 3/04845

(57) ABSTRACT

A display reproduces a video. The display displays a seek bar in which a slider moves on a line-shaped object in accordance with progress of a reproduction of the video and a position of the slider on the line-shaped object indicates a reproduced part of the video. The line-shaped object has a curved shape in accordance with information according to the reproduced part. The position of the slider indicates the reproduced part and the information according to the reproduced part.

### CROSS-REFERENCE TO RELATED APPLICATION

The present application is a National Phase entry based on PCT Application No. PCT/JP2017/004572 filed on Feb. 8, 2017, which claims the benefit of Japanese Application No. 2016-032976, filed on Feb. 24, 2016. PCT Application No. PCT/JP2017/004572 is entitled “ELECTRONIC DEVICE, CONTROL DEVICE, RECORDING MEDIUM, AND DISPLAY METHOD”, and Japanese Application No. 2016-032976 is entitled “ELECTRONIC APPARATUS, CONTROL DEVICE, CONTROL PROGRAM, AND DISPLAY METHOD”.

### TECHNICAL FIELD

Embodiments of the present disclosure relate to an electronic apparatus.

### BACKGROUND ART

Various techniques relating to an electronic apparatus are conventionally proposed.

### SUMMARY

An electronic apparatus, control device, recording medium, and display method are disclosed. In one embodiment, an electronic apparatus comprises a display. The display reproduces a video. The display displays a seek bar in which a slider moves on a line-shaped object in accordance with progress of a reproduction of the video and a position of the slider on the line-shaped object indicates a reproduced part of the video. The line-shaped object has a curved shape in accordance with first information according to the reproduced part. The position of the slider indicates the reproduced part and the first information according to the reproduced part.

In one embodiment, a control device is a control device being included in an electronic apparatus reproducing a video for controlling the electronic apparatus. The control device makes the electronic apparatus reproduce the video. The control device makes the electronic apparatus display a seek bar in which a slider moves on a line-shaped object in accordance with progress of a reproduction of the video and a position of the slider on the line-shaped object indicates a reproduced part of the video. The line-shaped object has a curved shape in accordance with information according to the reproduced part. The position of the slider indicates the reproduced part and the information according to the reproduced part.

In one embodiment, a recording medium is a computer-readable non-transitory recording medium storing a control program for controlling an electronic apparatus reproducing a video. The control program makes the electronic apparatus reproduce the video. The control program makes the electronic apparatus display a seek bar in which a slider moves on a line-shaped object in accordance with progress of a reproduction of the video and a position of the slider on the line-shaped object indicates a reproduced part of the video. The line-shaped object has a curved shape in accordance with information according to the reproduced part. The position of the slider indicates the reproduced part and the information according to the reproduced part.

In one embodiment, a display method is a display method in an electronic apparatus. The display method comprises displaying a seek bar in which a slider moves on a line-shaped object in accordance with progress of a reproduction of the video and a position of the slider on the line-shaped object indicates a reproduced part of the video. The line-shaped object has a curved shape in accordance with information according to the reproduced part. The position of the slider indicates the reproduced part and the information according to the reproduced part.

### BRIEF DESCRIPTION OF DRAWINGS

FIG. 1 A perspective view showing one example of an external appearance of an electronic apparatus.

FIG. 2 A rear view showing one example of the external appearance of the electronic apparatus.

FIG. 3 A drawing showing one example of a configuration of the electronic apparatus.

FIG. 4 A drawing showing one example of a configuration of the electronic apparatus.

FIG. 5 A drawing showing one example of a state of display of the electronic apparatus.

FIG. 6 A flow chart showing one example of an operation of the electronic apparatus.

FIG. 7 A drawing showing one example of a screen.

FIG. 8 A flow chart showing one example of an operation of the electronic apparatus.

FIG. 9 A drawing showing one example of a screen.

FIG. 10 A drawing showing one example of a screen.

FIG. 11 A drawing for describing one example of a seek bar.

FIG. 12 A drawing showing one example of information stored in the electronic apparatus.

FIG. 13 A drawing showing one example of the screen.

FIG. 14 A drawing showing one example of the screen.

FIG. 15 A drawing showing one example of the screen.

FIG. 16 A drawing showing one example of the screen.

FIG. 17 A drawing showing one example of the screen.

FIG. 18 A drawing showing one example of the screen.

FIG. 19 A drawing showing one example of the screen.

FIG. 20 A drawing showing one example of the screen.

FIG. 21 A drawing showing one example of the screen.

FIG. 22 A drawing showing one example of the screen.

FIG. 23 A drawing showing one example of the screen.

FIG. 24 A drawing showing one example of the screen.

FIG. 25 A drawing showing one example of the screen.

FIG. 26 A drawing showing one example of the screen.

FIG. 27 A drawing showing one example of the screen.

FIG. 28 A drawing showing one example of the screen.

FIG. 29 A drawing showing one example of the screen.

FIG. 30 A drawing for describing one example of a shooting indicator.

FIG. 31 A drawing showing one example of the screen.

FIG. 32 A drawing showing one example of the screen.

FIG. 33 A drawing showing one example of the screen.

FIG. 34 A drawing showing one example of the screen.

FIG. 35 A drawing showing one example of the screen.

FIG. 36 A drawing showing one example of the screen.

FIG. 37 A drawing showing one example of the screen.

FIG. 38 A drawing showing one example of the screen.

### DESCRIPTION OF EMBODIMENT(S)

### External Appearance of Electronic Apparatus

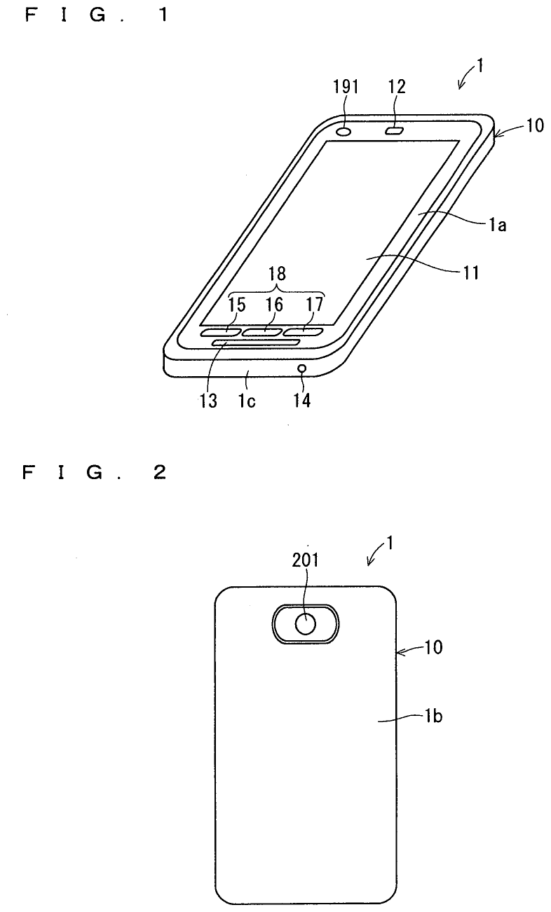

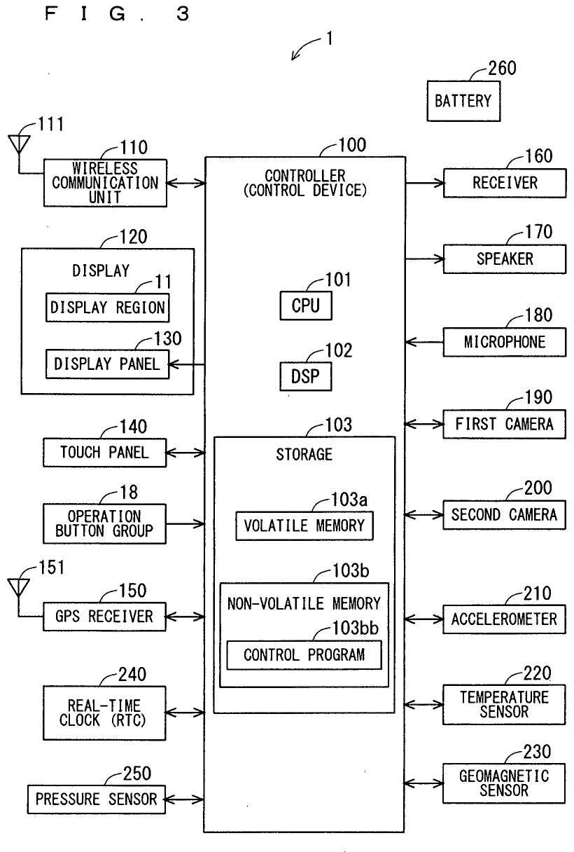

FIGS. 1 and 2 are a perspective view and a rear view showing one example of an external appearance of an electronic apparatus 1, respectively. The electronic apparatus 1 is, for example, a mobile phone such as a smartphone.

As shown in FIGS. 1 and 2, the electronic apparatus 1 comprises an apparatus case 10 having a plate shape substantially rectangular in a plan view. The apparatus case 10 constitutes an exterior of the electronic apparatus 1. A display region 11, in which various types of information such as characters, symbols, and graphics are displayed, is located in a front surface 1a of the electronic apparatus 1, in other words, a front surface of the apparatus case 10. A touch panel 140, which will be described below, is located in a rear surface side of the display region 11. Accordingly, a user can input various types of information to the electronic apparatus 1 by operating the display region 11 with his/her finger, for example. The user can also input the various types of information to the electronic apparatus 1 by operating the display region 11 with a pen for the touch panel such as a stylus pen, for example, instead of an operator such as his/her finger.

A receiver hole 12 is located in an upper end of the front surface 1a of the electronic apparatus 1 (the front surface of the apparatus case 10). A speaker hole 13 is located in a lower end of the front surface 1a of the electronic apparatus 1. A microphone hole 14 is located in a lower side surface 1c of the electronic apparatus 1.

A lens 191 included in a first camera 190, which will be described below, can be visually recognized from the upper end of the front surface 1a of the electronic apparatus 1. As shown in FIG. 2, a lens 201 included in a second camera 200, which will be described below, can be visually recognized from an upper end of a rear surface 1b of the electronic apparatus 1.

An operation button group 18 having a plurality of operation buttons 15, 16, and 17 is located in a lower end of the front surface 1a of the electronic apparatus 1. Each of the operation buttons 15, 16, and 17 is a hardware button. Specifically, each of the operation buttons 15, 16, and 17 is a press button. Each of the operation buttons 15, 16, and 17 may also be a software button displayed in the display region 11.

The operation button 15 is a back button, for example. The back button is an operation button for switching a display in the display region 11 to an immediately preceding display. The user operates the operation button 15 to switch the display in the display region 11 to the immediately preceding display.

The operation button 16 is a home button, for example. The home button is an operation button for displaying a home screen in the display region 11. The user operates the operation button 16 to display the home screen in the display region 11.

The operation button 17 is a history button, for example. The history button is an operation button to display a history of an application executed by the electronic apparatus 1 in the display region 11. When the user operates the operation button 17, the history of the application executed by the electronic apparatus 1 is displayed in the display region 11.

### Electrical Configuration of Electronic Apparatus

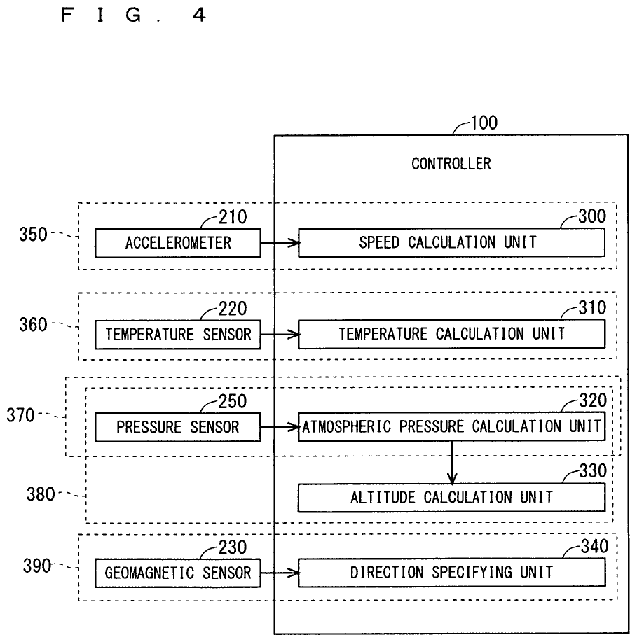

FIG. 3 is a block diagram mainly showing one example of an electrical configuration of the electronic apparatus 1. As shown in FIG. 3, the electronic apparatus 1 comprises a controller 100, a wireless communication unit 110, a display 120, the touch panel 140, the operation button group 18, and a GPS receiver 150. The electronic apparatus 1 further comprises a receiver 160, a speaker 170, a microphone 180, the first camera 190, and the second camera 200. The electronic apparatus 1 further comprises an accelerometer 210, a temperature sensor 220, a geomagnetic sensor 230, a real-time clock (referred to as an “RTC” hereinafter) 240, a pressure sensor 250, and a battery 260. The apparatus case 10 houses these components included in the electronic apparatus 1.

The controller 100 is a type of arithmetic processing device, and is a type of electrical circuit. The controller 100 controls the other components of the electronic apparatus 1 to be able to collectively manage the operation of the electronic apparatus 1. The controller 100 includes at least one processor for providing control and processing capability to execute various functions as described in detail below.

In accordance with various embodiments, the at least one processor may be executed as a single integrated circuit (IC) or as multiple communicatively coupled IC's and/or discrete circuits. The at least one processor can be executed in accordance with various known techniques.

In one embodiment, the processor includes one or more circuits or units configurable to perform one or more data computing procedures or processes by executing instructions stored in an associated memory, for example. In the other embodiment, the processor may be firmware configurable to perform one or more data computing procedures or processes (a discrete logic component, for example).

In accordance with various embodiments, the processor may comprise one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described below.

As shown in FIG. 3, the controller 100 includes a central processing unit (CPU) 101, a digital signal processor (DSP) 102, and a storage 103, for example. The controller 100 may further include a co-processor such as System-on-a-Chip (SoC), Micro Control Unit (MCU), and Field-programmable Gate Array (FPGA), for example. In this case, the controller 100 may make the CPU 101 and the co-processor cooperate with each other to perform various types of control, or may switch and use one of them to perform various types of control. The controller 100 is also considered as a control device 100.

The storage 103 comprises a volatile memory 103a such as a random access memory (RAM) and a non-volatile memory 103b such as a flash read only memory (ROM). Each of the volatile memory 103a and the non-volatile memory 103b is a non-transitory recording medium readable by the CPU 101 and the DSP 102. The non-volatile memory 103b stores a plurality of control programs 103bb to control the electronic apparatus 1. The CPU 101 and the DSP 102 execute the various control programs 103bb in the storage 103 to achieve various functions of the controller 100.

All or some of the functions of the controller 100 may be achieved by a hardware circuit that needs no software to achieve the functions above. The storage 103 may include a non-transitory computer readable recording medium other than the ROM and the RAM. The storage 103 may include, for example, a compact hard disk drive and a solid state drive (SSD).

The plurality of control programs 103bb in the storage 103 include various applications (application programs). The storage 103 stores, for example, a call application to perform a voice call and a video call, a browser to display a website, and a mail application to create, browse, send, and receive an e-mail. The storage 103 also stores a camera application to take a picture of an object using the first camera 190 and the second camera 200, a video reproduction application to reproduce a video, a map display application to display a map, and a music reproduction control application to control a reproduction of music data. The storage 103 may store at least one application in the storage 103 in advance. The electronic apparatus 1 may download the at least one application in the storage 103 from the other device and store it in the storage 103.

The wireless communication unit 110 includes an antenna 111. The wireless communication unit 110 can perform a wireless communication under control of the controller 100, using the antenna 111. The wireless communication unit 110 can receive a signal from a mobile phone different from the electronic apparatus 1 or a signal from a communication device such as a web server connected to Internet by the antenna 111 via a base station, for example. The wireless communication unit 110 can perform an amplification processing and a down-conversion on the received signal and output the processed signal to the controller 100. The controller 100 can perform a demodulation processing, for example, on the received signal which has been input, to acquire user data and control data, for example, contained in the received signal. The wireless communication unit 110 can perform an up-conversion and an amplification processing on the transmitted signal, which has been generated in the controller 100, containing the user data and the control data, and wirelessly transmit the transmitted signal which has been processed from the antenna 111. The mobile phone different from the electronic apparatus 1 or the communication device connected to Internet, for example, receives the transmitted signal from the antenna 111 via the base station, for example.

The display 120 has the display region 11 located in the front surface 1a of the electronic apparatus 1 and a display panel 130. The display 120 can display various types of information in the display region 11. The display panel 130 is a liquid crystal display panel or an organic EL panel, for example. The display panel 130 can display various types of information such as characters, symbols, and graphics under control of the controller 100. The display panel 130 faces the display region 11 in the apparatus case 10. The information displayed on the display panel 130 is displayed in the display region 11.

The touch panel 140 can detect an operation performed on the display region 11 with the operator such as the finger. The touch panel 140 is, for example, a projected capacitive touch panel. The touch panel 140 is located on a back side of the display region 11, for example. When the user performs the operation on the display region 11 with the operator such as his/her finger, the touch panel 140 can input, to the controller 100, an electrical signal in accordance with the operation. The controller 100 can specify contents of the operation performed on the display region 11 based on the electrical signal from the touch panel 140 and perform processing in accordance with the contents.

When the user operates the operation buttons 15, 16, and 17 of the operation button group 18, each of the operation buttons 15, 16, and 17 can output to the controller 100 an operation signal indicating that each of the operation buttons 15, 16, and 17 has been operated. The controller 100 can accordingly determine whether or not each operation button has been operated for each of the operation buttons 15, 16, and 17. The controller 100 to which the operation signal is input controls the other component, thereby causing the electronic apparatus 1 to execute the function allocated to the operated operation button described above.

The GPS receiver 150 has an antenna 151. The GPS receiver 150 can receive a wireless signal from a satellite of Global Positioning System (GPS) under control of the controller 100, using the antenna 151. The GPS receiver 150 can calculate a current position of the electronic apparatus 1 based on the received wireless signal. The current position obtained in the GPS receiver 150 is input to the controller 100. The GPS receiver 150 functions as a position acquisition unit to acquire a current position of the electronic apparatus 1.

The microphone 180 can convert a sound from the outside of the electronic apparatus 1 into an electrical sound signal and then output the electrical sound signal to the controller 100. The sound from the outside of the electronic apparatus 1 is taken inside the electronic apparatus 1 through the microphone hole 14 and input to the microphone 180.

The speaker 170 is, for example, a dynamic speaker. The speaker 170 can convert an electrical sound signal from the controller 100 into a sound and then output the sound. The sound being output from the speaker 170 is output outside through the speaker hole 13. The sound being output from the speaker hole 13 can be heard in a place apart from the electronic apparatus 1.

The receiver 160 can output a received sound. The receiver 160 is, for example, a dynamic speaker. The receiver 160 can convert an electrical sound signal from the controller 100 into a sound and then output the sound. The sound being output from the receiver 160 is output outside through the receiver hole 12. A volume of the sound being output through the receiver hole 12 is set to be smaller than a volume of the sound being output through the speaker hole 13. The sound being output through the receiver hole 12 can be heard when the user brings the receiver hole 12 close to his/her ear. The electronic apparatus 1 may comprise a vibration element such as a piezoelectric vibration element for causing a portion of the front surface of the apparatus case 10 to vibrate instead of the receiver 160. In the above case, the sound is transmitted to the user from the portion of the front surface.

The first camera 190 comprises the lens 191 and an imaging element, for example. The second camera 200 has the lens 201 and an imaging element, for example. Each of the first camera 190 and the second camera 200 can take a still image or a video under control of the controller 100 and then output the still image or the video to the controller 100.

The lens 191 of the first camera 190 can be visually recognized from the front surface 1a of the electronic apparatus 1. Accordingly, the first camera 190 can take an image of an object located on a side of the front surface 1a (a side of the display region 11) of the electronic apparatus 1. The lens 201 of the second camera 200 can be visually recognized from the rear surface 1b of the electronic apparatus 1. Accordingly, the second camera 200 can take an image of an object located on the side of the rear surface 1b of the electronic apparatus 1. The first camera 190 is referred to as the “in-camera 190”, and the second camera 200 is referred to as the “out-camera 200” in some cases hereinafter. Each of the in-camera 190 and the out-camera 200 may be simply referred to as “the camera” in a case where they need not be specifically distinguished from each other.

The accelerometer 210 can detect an acceleration rate of the electronic apparatus 1 and output a detection signal in accordance with the detected acceleration rate to the controller 100. The controller 100 can operate the accelerometer 210 and stop the operation of the accelerometer 210.

The temperature sensor 220 can detect a temperature of the electronic apparatus 1 and output a detection signal in accordance with the detected temperature to the controller 100. The controller 100 can operate the temperature sensor 220 and stop the operation of the temperature sensor 220.

The geomagnetic sensor 230 can detect geomagnetism and output a detection signal in accordance with the detected geomagnetism to the controller 100. The controller 100 can operate the geomagnetic sensor 230 and stop the operation of the geomagnetic sensor 230.

The RTC 240 can measure a current date and time and output the current date and time to the controller 100. The RTC 240 functions as a date and time acquisition unit to acquire the current date and time.

The pressure sensor 250 can detect a pressure of a gas and a liquid. The pressure sensor 250 can detect a pressure on the electronic apparatus 1 and output a detection signal in accordance with the detected pressure. The controller 100 can operate the pressure sensor 250 and stop the operation of the pressure sensor 250.

The battery 260 can output a power source for the electronic apparatus 1. The battery 260 is, for example, a rechargeable battery. The battery 260 can supply the power source to various components such as the controller 100 and the wireless communication unit 110 included in the electronic apparatus 1.

### Function Block in Controller

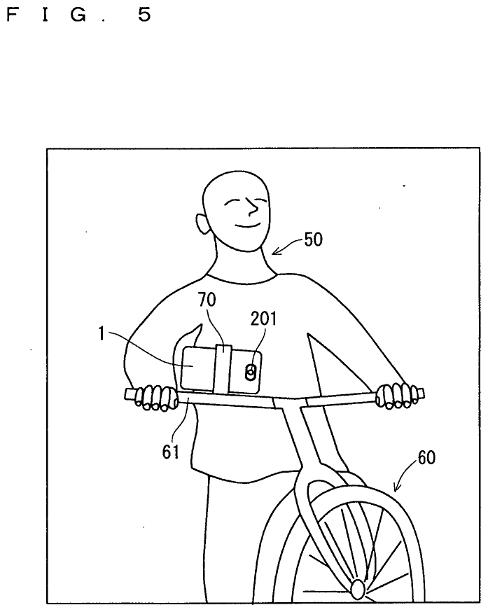

FIG. 4 is a drawing showing one example of function blocks formed when the CPU 101 and the DSP 102 execute the control program 103bb in the storage 103. As shown in FIG. 4, the controller 100 comprises a speed calculation unit 300, a temperature calculation unit 310, an atmospheric pressure calculation unit 320, an altitude calculation unit 330, and a direction specifying unit 340 as the function blocks. Some or all of these function blocks may be achieved by a hardware circuit that needs no software to execute the functions above.

The electronic apparatus 1 has a speed acquisition unit 350 capable of acquiring a speed of the electronic apparatus 1. The speed acquisition unit 350 has the accelerometer 210 and the speed calculation unit 300. The speed calculation unit 300 can calculate the speed of the electronic apparatus 1 based on the detection signal being output from the accelerometer 210. Hereinafter, “the speed” means the speed of the electronic apparatus 1 unless otherwise described.

The electronic apparatus 1 has a temperature acquisition unit 360 capable of acquiring a temperature of the electronic apparatus 1. The temperature acquisition unit 360 has the temperature sensor 220 and the temperature calculation unit 310. The temperature calculation unit 310 can calculate the temperature of the electronic apparatus 1 based on the detection signal being output from the temperature sensor 220. Hereinafter, “the temperature” means the temperature of the electronic apparatus 1 unless otherwise described.

The electronic apparatus 1 comprises an atmospheric pressure acquisition unit 370 capable of acquiring an atmospheric pressure around the electronic apparatus 1 and an altitude acquisition unit 380 capable of acquiring an altitude of a position of the electronic apparatus 1. The atmospheric pressure acquisition unit 370 has the pressure sensor 250 and the atmospheric pressure calculation unit 320. The altitude acquisition unit 380 has the pressure sensor 250, the atmospheric pressure calculation unit 320, and the altitude calculation unit 330. The atmospheric pressure calculation unit 320 can calculate the atmospheric pressure around the electronic apparatus 1 based on the detection signal being output from the pressure sensor 250. The altitude calculation unit 330 can calculate the altitude of the position of the electronic apparatus 1 based on the atmospheric pressure obtained in the atmospheric pressure calculation unit 320. Hereinafter, “the altitude” means the altitude of the position of the electronic apparatus 1 unless otherwise described.

The electronic apparatus 1 comprises a direction acquisition unit 390 capable of acquiring a direction in which lenses of the in-camera 190 and the out-camera 200 face. The direction acquisition unit 390 has the geomagnetic sensor 230 and the direction specifying unit 340. The direction specifying unit 340 can specify the direction in which the lens 191 of the in-camera 190 faces based on the detection signal being output from the geomagnetic sensor 230. The direction specifying unit 340 can specify the direction in which the lens 201 of the out-camera 200 faces based on the detection signal being output from the geomagnetic sensor 230.

### Description of Video Shooting

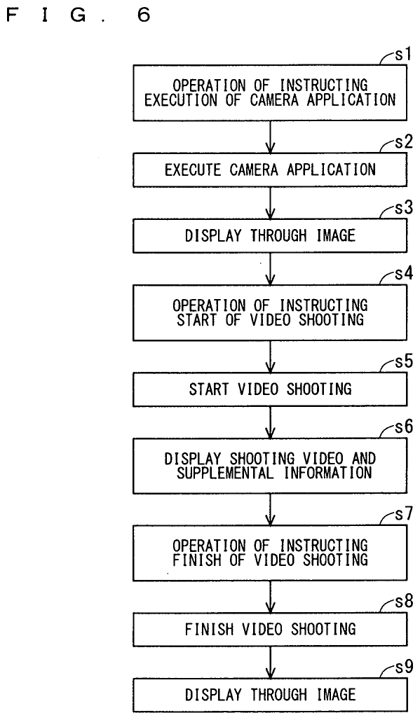

FIG. 5 is a drawing showing one example of a state of display of the electronic apparatus 1 taking a video. In the example shown in FIG. 5, the electronic apparatus 1 takes the video using the out-camera 200. The electronic apparatus 1 is fixed to a handle 61 of a bicycle 60 which a user 50 rides by a fixing member 70. The electronic apparatus 1 is fixed to the handle 61 so that the lens 201 of the out-camera 200 faces in a traveling direction of the bicycle 60. Accordingly, the out-camera 200 takes the video of an object located in the traveling direction of the bicycle 60.

The electronic apparatus 1 may take the video with the in-camera 190. The state of display of the electronic apparatus 1 taking the video is not limited to the example in FIG. 5. For example, the user may make the electronic apparatus 1 take the video with the electronic apparatus 1 in his/her hand. It is also applicable that a neck strap is attached to the electronic apparatus 1 and the user makes the electronic apparatus 1 take the video with the neck strap around his/her neck.

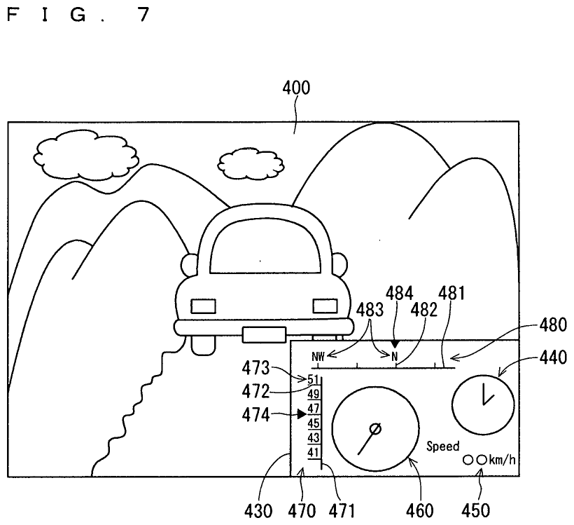

FIG. 6 is a flow chart showing one example of an operation of the electronic apparatus 1 at the time of taking the video. The electronic apparatus 1 acquires the various types of information during the video shooting, and displays the acquired information with the video which is being taken. This information is referred to as the “shooting supplemental information”. The shooting supplemental information includes, for example, a speed, a time, an altitude, and a direction in which a lens of a camera being used to take the video faces. The direction in which the lens of the camera being used to take the video faces is simply referred to as the “direction of the camera lens” in some cases hereinafter. The camera used to take the video is referred to as the “camera being used” in some cases.

As shown in FIG. 6, if the touch panel 140 receives an execution instruction operation for instructing to execute the camera application in Step s1, the controller 100 reads out and executes the camera application in the storage 103 in Step s2. If the camera application is executed, the display 120 displays a through image taken with the camera being used under control of the controller 100 in Step s3. The user can determine which of the in-camera 190 or the out-camera 200 is used as the camera being used by operating the display region 11. The through image is a video for the user to confirm the object in a shooting range taken with the camera being used in real time. The through image is also referred to as a live view image or a preview image. The through image taken with the camera being used is temporarily stored in the volatile memory 103a. The controller 100 reads out the through image from the volatile memory 103a to make the display 120 display the through image.

Next, if the touch panel 140 receives a start instruction operation for instructing to start the video shooting in Step s4, the controller 100 makes the camera being used start taking the video in Step s5. The video taken with the camera being used is stored in the non-volatile memory 103b. The video taken with the camera being used means not the through image but the video stored in the non-volatile memory 103b unless otherwise described. The video taken with the camera being used and stored in the non-volatile memory 103b is simply referred to as the “shooting video” in some cases.

If the camera being used starts the video shooting, the controller 100 makes the display 120 display the shooting video and the shooting supplemental information in Step s6. While the camera being used takes the video, the display 120 displays the video taken with the camera being used and the shooting supplemental information acquired in parallel with the video shooting in real time.

Herein, if the touch panel 140 receives the start instruction operation for instructing to start the video shooting, the controller 100 activates components, each of which is necessary to acquire the shooting supplemental information but stops its operation. Specifically, the controller 100 activates the accelerometer 210, the geomagnetic sensor 230, and the pressure sensor 250, each of which stops its operation. The speed acquisition unit 350 having the accelerometer 210 thereby starts acquiring the speed. The altitude acquisition unit 380 having the pressure sensor 250 starts acquiring the altitude. The direction acquisition unit 390 having the geomagnetic sensor 230 starts acquiring the direction of the camera lens. Since the RTC 240 always operates, for example, while the electronic apparatus 1 operates, the RTC 240 operates when the touch panel 140 receives the start instruction operation for instructing to start the video shooting.

When the camera being used starts the video shooting, the controller 100 makes the display 120 display the video taken with the camera being used and the shooting supplemental information acquired in parallel with the video shooting, that is the speed, the time, the altitude, and the direction of the camera lens in the present example, in real time.

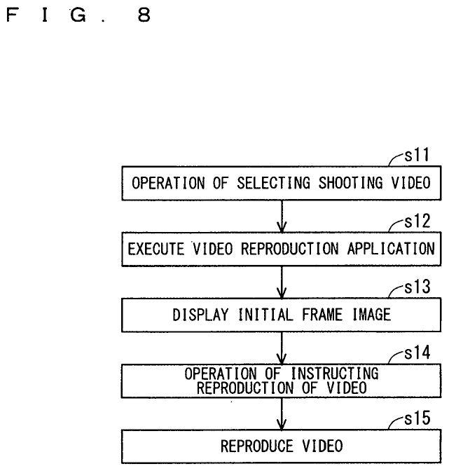

FIG. 7 is a drawing showing one example of a screen displayed on the display 120 during the video shooting. A shooting video 400 is displayed in the display region 11. A supplemental information screen 430 including the shooting supplemental information is displayed to have an overlap with the shooting video 400 in the display region 11, for example.

The supplemental information screen 430 includes an analog clock 440 indicating a current time acquired by the RTC 240. The supplemental information screen 430 includes speed information 450 indicating a current speed acquired by the speed acquisition unit 350 by a numeral value and an analog type speed meter 460 indicating the current speed. The supplemental information screen 430 includes altitude information 470 indicating a current altitude acquired by the altitude acquisition unit 380 and direction information 480 indicating a current direction of the camera lens acquired by the direction acquisition unit 390.

The altitude information 470 includes a scale axis 471 on which a plurality of scales 472 are marked. A numeral value 473 are marked on each scale 472. The altitude information 470 includes a triangle mark 474 pointing the scale 472 corresponding to the current altitude. The numeral value 473 marked on the scale 472 pointed by the mark 474 indicates the current altitude.

The direction information 480 includes the scale axis 481 on which a plurality of scales 482 each indicating a direction are marked. Characters 483 each indicating a direction are marked on some of the plurality of scales 482. The character 483 of “N” shown in FIG. 7 means “north” and the character 483 of “NW” means “northwest”. The direction information 480 includes a triangle mark 484 pointing the scale 482 corresponding to the current direction of the camera lens. The direction indicated by the character 483 marked on the scale 482 pointed by the mark 484 indicates the current direction of the camera lens. In a case where the direction in which the user proceeds and the direction in which the lens 210 of the out-camera 200, which is the camera being used, faces coincide with each other as the example in FIG. 5, the direction of the camera lens means the direction in which the user proceeds. That is to say, in this case, the display 120 displays the direction in which the user moves together with the shooting video 400.

After Step s6, if the touch panel 140 receives a finish instruction operation for instructing to finish the video shooting in Step s7, the controller 100 makes the camera being used finish taking the video in Step s8. Next, the controller 100 makes the display 120 display the through image taken with the camera being used in Step s9. If the video shooting is finished, the display 120 does not display the shooting supplemental information.

The shooting supplemental information may include only some of the speed, the time, the altitude, and the direction of the camera lens. The shooting supplemental information may also include information other than the speed, the time, the altitude, and the direction of the camera lens. The shooting supplemental information may also include a current position of the electronic apparatus 1 acquired by the GPS receiver 150, for example. The shooting supplemental information may also include a temperature acquired by the temperature acquisition unit 360. The shooting supplemental information may also include an atmospheric pressure acquired by the atmospheric pressure acquisition unit 370.

### Description of Video Reproduction

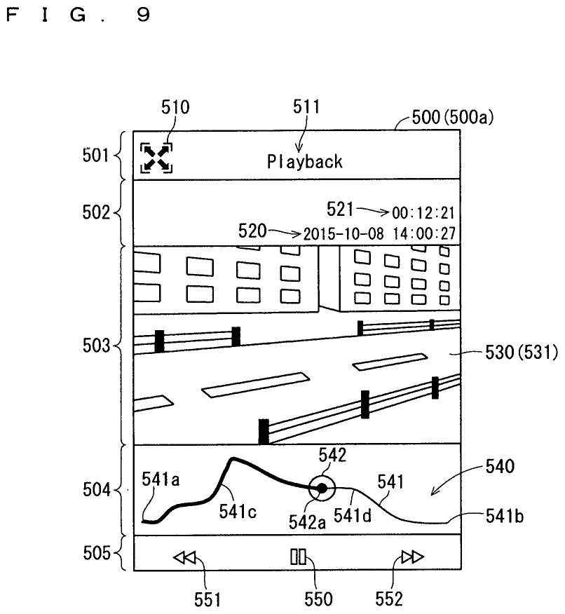

FIG. 8 is a flow chart showing an operation of the electronic apparatus 1 at the time of reproducing the shooting video. As shown in FIG. 8, if the touch panel 140 receives a selection operation for selecting the shooting video in the non-volatile memory 103b in Step s11, the controller 100 executes a video reproduction application in the non-volatile memory 103b in Step s12. Then, in Step s13, the controller 100 determines the selected shooting video to be reproduced, and makes the display 120 display an initial frame image of the shooting video to be reproduced, for example. Subsequently, if the touch panel 140 receives a reproduction instruction operation for instructing to reproduce the shooting video to be reproduced in Step s14, the controller 100 makes the display 120 reproduce the shooting video to be reproduced in Step s15.

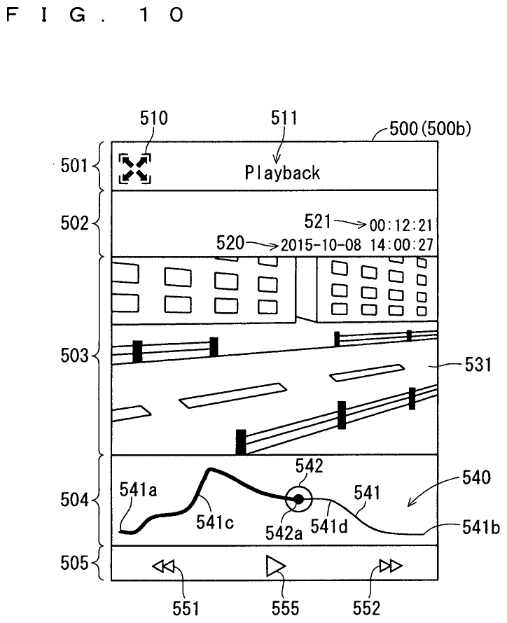

FIG. 9 is a drawing showing one example of a reproduction screen 500 which the display 120 displays under control of the controller 100 during the execution of the video reproduction application. FIG. 9 shows the reproduction screen 500 in which the video is being playbacked. The reproduction screen 500 includes partial screens 501 to 505. The partial screens 501 to 505 are arranged in this order from above in the reproduction screen 500.

The partial screen 501 shows a full-screen display button 510 and a character string 511 indicating that the screen displayed on the display 120 is the reproduction screen 500.

The partial screen 502 includes a shooting date and time 520 of a frame image in a currently-reproduced part of the video which is being reproduced. The controller 100 specifies the shooting date and time of each frame image of the video while the video is taken with the camera being used based on the date and time being output from the RTC 240. Then, the controller 100 associates each frame image with its shooting date and time, and stores them in the non-volatile memory 103b. Accordingly, the display 120 can display the shooting date and time 520 of the frame image in the currently-reproduced part of the video 530 which is being reproduced, that is to say, the frame image which is currently displayed, under control of controller 100. The shooting date and time 520 changes from moment to moment during the reproduction of the video 530. The partial screen 502 shows a reproduction time 521 of the video 530. The controller 100 can obtain the reproduction time 521 based on the date and time being output from the RTC 240.

The partial screen 503 shows the video 530 being reproduced. The partial screen 503 sequentially displays each frame image 531 of the video 530 which is being reproduced. The partial screen 504 shows a seek bar 540 indicating the currently-reproduced part of the video 530 which is being reproduced. The seek bar is also referred to as a progress bar or a reproduction indicator. The partial screen 505 shows a pause button 550, a fast-backward button 551, and a fast-forward button 552.

If the touch panel 140 detects a predetermined operation (a tap operation, for example) performed on the full-screen display button 510, the controller 100 makes the display 120 display the video 530 in almost the whole display region 11.

If the touch panel 140 detects a predetermined operation (a long-tap operation, for example) performed on the fast-backward button 551, the controller 100 turns back the reproduced part of the video 530 which is reproduced by the display 120 to the previous one. The controller 100 turns back the reproduced part of the video 530 to the previous one while the user touches the fast-backward button 551 with an operator such as his/her finger.

If the touch panel 140 detects a predetermined operation (a long-tap operation, for example) performed on the fast-forward button 552, the controller 100 moves the reproduced part of the video 530 which is reproduced by the display 120 forward. The controller 100 moves the reproduced part of the video 530 forward while the user touches the fast-forward button 551 with the operator such as his/her finger.

If the touch panel 140 detects a predetermined operation (a tap operation, for example) performed on the pause button 550, the controller 100 controls the display 120 so that the reproduction of the video 530 in the display 120 is stopped. At this time, the reproduction of the video 530 is stopped in the reproduced part of the video 530 when the touch panel 140 detects the predetermined operation performed on the pause button 550.

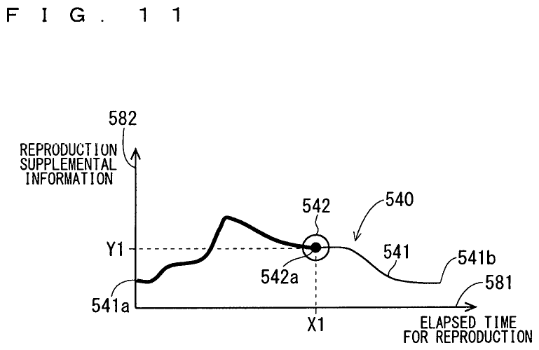

FIG. 10 is a drawing showing one example of the reproduction screen 500 in a case where the playback of the video 530 is stopped. In the case where the reproduction of the video 530 is stopped, the partial screen 505 shows a play button 555 instead of the pause button 550. The partial screen 503 shows the frame image 531 of the reproduced part of the video 530 when the predetermined operation is performed on the pause button 550. If the touch panel 140 detects a predetermined operation (a tap operation, for example) performed on the play button 555, the controller 100 makes the display 120 start the reproduction of the video 530 from the part in which the reproduction is stopped. In other words, the controller 100 makes the display 120 start the reproduction of the video 530 from the frame image 531 shown in the partial screen 503. The predetermined operation performed on the play button 555 is the reproduction instruction operation described above.

The reproduction screen 500 in which the video is being reproduced is referred to as a “reproduction screen 500a” and the reproduction screen 500 in which the reproduction of the video is stopped is referred to as a “reproduction screen 500b” in some cases.

### Detail of Seek Bar

The seek bar 540 is described in detail next. In the seek bar 540, a slider 542 moves on a line-shaped object 541 in accordance with a progress of the reproduction of the video 530. The slider 542 moves on the line-shaped object 541 from left to right as the reproduction of the video 530 proceeds. A position of the slider 542 on the line-shaped object 541 indicates a currently-reproduced part of the video 530 which is being reproduced. In the present example, if a center 542a of the slider 542 is located in a left end 541a of the line-shaped object 541, the reproduced part of the video 530 falls on an initial frame image. If the center 542a of the slider 542 is located in a right end 541b of the line-shaped object 541, the reproduced part of the video 530 falls on a last frame image.

As shown in FIG. 10, if the reproduction of the video 530 is stopped, the position of the slider 542 on the line-shaped object 541 indicates a reproduction stop part in the video 530. If the center 542a of the slider 542 is located in the left end 541a of the line-shaped object 541 in the state where the reproduction of the video 530 is stopped, the reproduction of the video 530 is stopped at the initial frame image. If the center 542a of the slider 542 is located in the right end 541b of the line-shaped object 541, the reproduction of the video 530 is stopped at the last frame image. If the predetermined operation is performed on the play button 555, the reproduction of the video 530 is started from the part in which the reproduction is stopped, thus the position of the slider 542 on the line-shaped object 541 is deemed to indicate the reproduced part of the video 530 which is reproduced first when the reproduction of the video 530 is started.

As described above, the position of the slider 542 on the line-shaped object 541 is deemed to indicate the reproduced part of the video 530 regardless of whether the video 530 is reproduced or the reproduction of the video 530 is stopped. In other words, the position of the slider 542 on the line-shaped object 541 is deemed to indicate which frame image in the video 530 the display 120 currently displays.

In the seek bar 540, a first portion 541c in the line-shaped object 541 corresponding to a part in which the reproduction of the video 530 is finished is displayed by a thick line. That is to say, a width of the first portion 541c located on a left side of the center 542a of the slider 542 in the line-shaped object 541 increases. In the meanwhile, a second portion 541d in the line-shaped object 541 corresponding to a part in which the reproduction of the video 530 is not yet finished is displayed by a thin line. That is to say, a width of the second portion 541d located on a right side of the center 542a of the slider 542 in the line-shaped object 541 decreases.

In the present example, the line-shaped object 541 has a curved shape in accordance with predetermined information according to the reproduced part of the video 530. Then, the predetermined information according to the reproduced part of the video 530 is indicated by the position of the slider 542 indicating the reproduced part. That is to say, the position of the slider 542 moving on the curved line-shaped object 541 indicates not only the reproduced part of the video 530 but also the predetermined information according to the reproduced part. This predetermined information is referred to as the “reproduction supplemental information” hereinafter. The curved line-shaped object means the linear object which does not have a straight shape. Accordingly, the curved line-shaped object includes a bent line-shaped object, a folded-line-shaped object, and a pulsed line-shaped object, for example. The curved line-shaped object is also deemed as the non-straight line-shaped object.

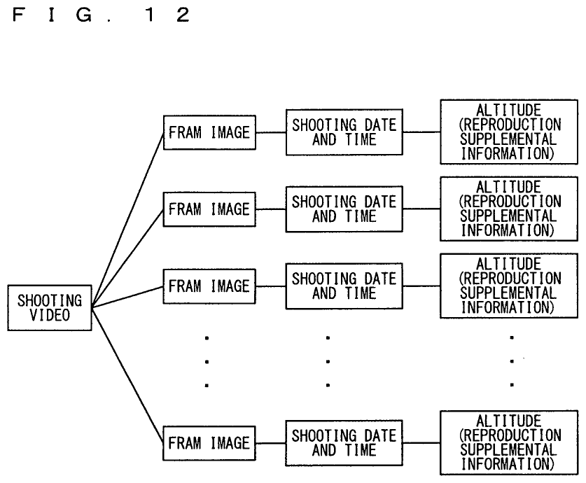

FIG. 11 is a drawing for describing one example of the seek bar 540. As shown in FIG. 11, the line-shaped object 541 of the seek bar 540 is expressed in a two-dimensional graph in which a first axis 581 indicates an elapsed time for the reproduction of the video 530 and a second axis 582 perpendicular to the first axis 581 indicates the reproduction supplemental information. Herein, the elapsed time for the reproduction means an elapsed time from the start of reproduction when the reproduction of the video 530 is started from its beginning. The first axis 581 is referred to as the “X axis 581” and the second axis 582 is referred to as the “Y axis 582” hereinafter for convenience of description. A direction along the X axis 581 is referred to as the “X axis direction”, and a direction along the Y axis 582 is referred to as the “Y axis direction”.

A position of the slider 542 on the line-shaped object 541 in the X axis direction indicates the reproduced part of the video 530. That is to say, the position of the slider 542 on the line-shaped object 541 in the X axis direction indicates the reproduced part which is reproduced when the elapsed time for the reproduction coincides with an X coordinate value X1 of the center 542a of the slider 542. In other words, the position of the slider 542 on the line-shaped object 541 in the X axis direction indicates the reproduced part which is reproduced when the X coordinate value X1 indicating the position has elapsed since the reproduction of the video 530 has been started from its beginning. During the reproduction of the video 530, the position of the slider 542 on the line-shaped object 541 in the X axis direction indicates the currently-reproduced part of the video 530. In a case where the reproduction of the video 530 is stopped, the position of the slider 542 on the line-shaped object 541 in the X axis direction indicates the reproduced part in which the reproduction of the video 530 is started, that is to say, the reproduced part which is reproduced first when the reproduction of the video 530 is started.

The X coordinate value on the left end 541a of the line-shaped object 541 indicates 0. The X coordinate value on the right end 541b of the line-shaped object 541 indicates the shooting time of the video 530. The X coordinate value on the right end 541b of the line-shaped object 541 is deemed to indicate a time necessary to reproduce the video 530 from beginning to end. If the shooting time is ten minutes, for example, the X coordinate value on the right end 541b of the line-shaped object 541 indicates ten minutes. A length of the line-shaped object 541 in the X axis direction is also deemed to indicate the shooting time of the video 530 which has been taken.

The position of the slider 542 on the line-shaped object 541 in the X axis direction is referred to as the “X axis direction position of the slider 542” hereinafter. The position of the slider 542 on the line-shaped object 541 in the Y axis direction is referred to as the “Y axis direction position of the slider 542”.

In the meanwhile, the Y axis direction position of the slider 542 indicates the reproduction supplemental information in accordance with the reproduced part indicated by the X axis direction position of the slider 542. A Y coordinate value Y1 of the center 542a of the slider 542 indicating the Y axis direction position of the slider 542 indicates the reproduction supplemental information in accordance with the reproduced part which is reproduced when the elapsed time for the reproduction coincides with the X coordinate value X1. In other words, the Y coordinate value Y1 indicates the reproduction supplemental information in accordance with the reproduced part which is reproduced when the X coordinate value X1 has elapsed since the reproduction of the video 530 has been started from its beginning. During the reproduction of the video 530, the Y axis direction position of the slider 542 indicates the reproduction supplemental information in accordance with the currently-reproduced part of the video 530. In the case where the reproduction of the video 530 is stopped, the Y axis direction position of the slider 542 indicates the reproduction supplemental information in accordance with the reproduced part which is reproduced first when the reproduction of the video 530 is started.

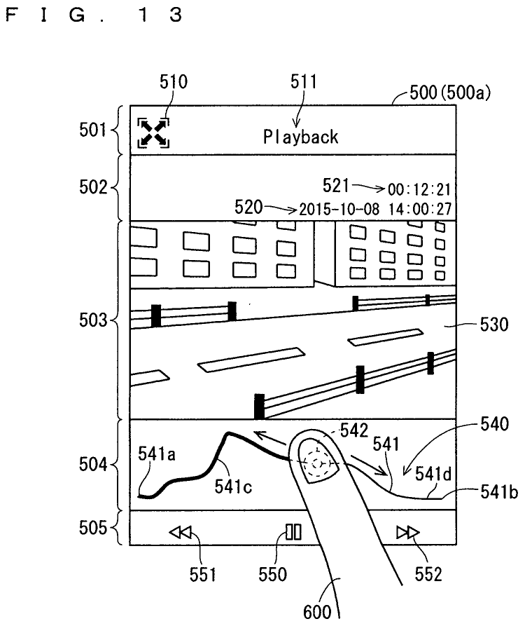

Adopted as the reproduction supplemental information is, for example, an altitude of a shooting position of a frame image of the video 530 at the time of taking the frame image. As described above, the controller 100 associates each frame image of the shooting video with its shooting date and time, and stores them in the non-volatile memory 103b. While the video is taken with the camera being used, the controller 100 further associates the altitude acquired by the altitude acquisition unit 380 at the time of taking the frame image of the video and the frame image, and stores them in the non-volatile memory 103b. The altitude acquired by the altitude acquisition unit 380 at the time of taking the frame image is deemed as the altitude of the position in which the electronic apparatus 1 is located at the time of taking the frame image. Accordingly, the altitude acquired by the altitude acquisition unit 380 at the time of taking the frame image is deemed as the altitude of the shooting position of the frame image at the time of taking the frame image. Thus, as shown in FIG. 12, the frame image of the shooting video, its shooting date and time, and the altitude of the shooting position of the frame image at the time of taking the frame image are associated with each other for each frame image, and stored in the non-volatile memory 103b. The altitude of the shooting position of the frame image at the time of taking the frame image is simply referred to as the “shooting position altitude” in some cases hereinafter.

In the case where the shooting position altitude of the frame image is adopted as the reproduction supplemental information, the Y axis 582 indicates the shooting position altitude of the frame image. The Y axis direction position of the slider 542 indicates the shooting position altitude of the frame image in the reproduced part indicated by the X axis direction position of the slider 542. The Y coordinate value Y1 of the center 542a of the slider 542 indicates the shooting position altitude of the frame image in the reproduced part which is reproduced when the elapsed time for the reproduction coincides with the X coordinate value X1 of the center 542a. During the reproduction of the video 530, the Y axis direction position of the slider 542 indicates the shooting position altitude of the frame image in the currently-reproduced part of the video 530. In the case where the reproduction of the video 530 is stopped, the Y axis direction position of the slider 542 indicates the shooting position altitude of the frame image in the reproduced part which is reproduced first when the reproduction of the video 530 is started. In the present example, the shooting position altitude indicated by the Y axis 582 increases toward a plus direction of the Y axis 582.

As described above, the frame image and the shooting position altitude of the frame image are associated with each other in the non-volatile memory 103b. The elapsed time for the reproduction and the shooting time can be specified from the shooting date and time associated with each frame image. Thus, the controller 100 can make the display 120 display the seek bar 540 shown in FIG. 11 based on the information in the non-volatile memory 103b. The X axis 581 and the Y axis 582 shown in FIG. 11 are not shown in the reproduction screen 500.

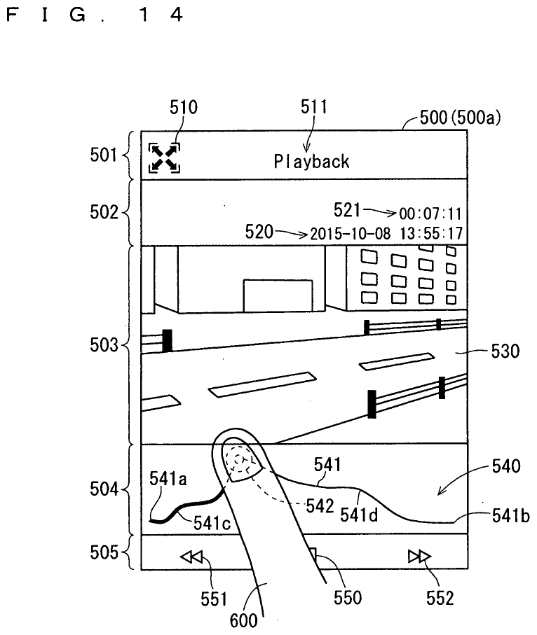

The user can make the electronic apparatus 1 change the position of the slider 542 on the line-shaped object 541 to be located in a desired position by operating the electronic apparatus 1 regardless of whether or not the reproduction of the video 530 is stopped. For example, as shown in FIG. 13, if the user moves a finger 600 of the user along the line-shaped object 541 with the finger 600 being in contact with the slider 542, the position of the slider 542 changes to follow the movement of the finger 600. That is to say, if the user moves the finger 600 along the line-shaped object 541 with the finger 600 being in contact with the slider 542, the position of the slider 542 changes so that the slider 542 is always in contact with the finger 600. Thus, the user can make the electronic apparatus 1 change the position of the slider 542 on the line-shaped object 541 to be located in the desired position. Thus, the user can make the electronic apparatus 1 start the reproduction of the video 530 from the desired part of the video 530.

If the user makes the operator such as his/her finger come in contact with the line-shaped object 541, the center 542a of the slider 542 comes to be located in a position where the operator comes in contact in the line-shaped object 541. Thus, the user can make the electronic apparatus 1 change the position of the slider 542 on the line-shaped object 541 to be located in the desired position.

As described above, in the seek bar 540, the position of the slider 542 on the curved line-shaped object 541 indicates only the reproduced part of the video 530 but also the reproduction supplemental information in accordance with the reproduced part. Thus, the user can easily find the desired part in the video 530 based on the reproduction supplemental information indicated by the position of the slider 542.

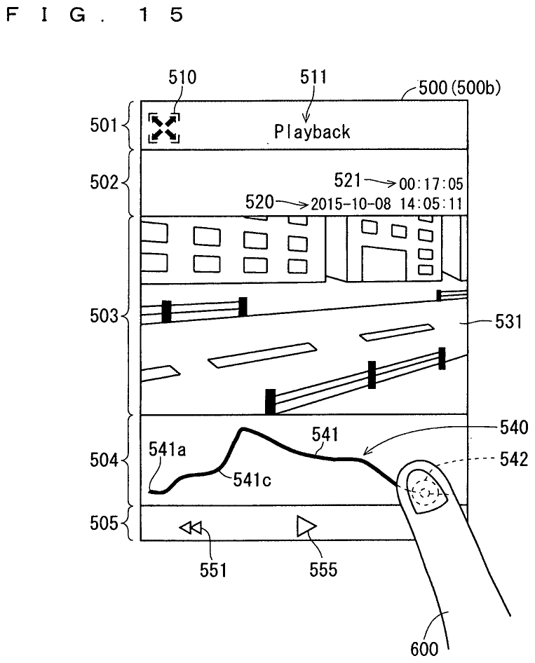

In the present example, the reproduction supplemental information is the shooting position altitude of the frame image, thus the user can easily find the desired part in the video 530 based on the shooting position altitude of the frame image indicated by the position of the slider 542. For example, the user can easily specify the part of the video 530 taken in a position located at a high altitude. Thus, the user can make the electronic apparatus 1 change the position of the slider 542 to the position in which the part taken in the position located at the high altitude is reproduced as shown in FIG. 14 by operating the slider 542 with the finger 600, for example. Accordingly, the user can confirm the frame image, in the partial screen 503 of the reproduction screen 500, taken in the position located at the high altitude.

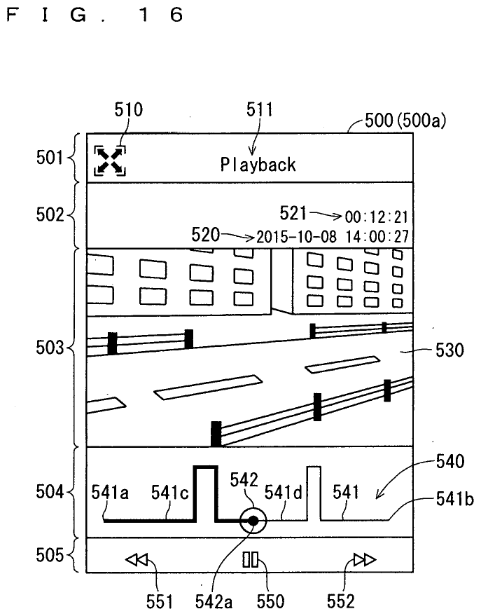

For example, the user can easily specify the part of the video 530 taken in a position located at a low altitude. Thus, the user can make the electronic apparatus 1 change the position of the slider 542 to the position in which the part taken in the position located at the low altitude is reproduced as shown in FIG. 15 by operating the slider 542 with the finger 600, for example. Accordingly, the user can confirm the frame image, in the partial screen 503 of the reproduction screen 500, taken in the position located at the low altitude

FIGS. 13 and 14 show the reproduction screen 500a in which the video 530 is being reproduced, and FIG. 15 shows the reproduction screen 500b in which the reproduction of the video 530 is stopped.

The reproduction supplemental information may be the information other than the shooting position altitude of the frame image. The reproduction supplemental information may be, for example, an atmospheric pressure in a shooting position of a frame image at the time of taking the frame image. In this case, while the video is taken with the camera being used, the controller 100 associates the atmospheric pressure acquired by the atmospheric pressure acquisition unit 370 at the time of taking the frame image of the video and the frame image, and stores them in the non-volatile memory 103b. The atmospheric pressure acquired by the atmospheric pressure acquisition unit 370 at the time of taking the frame image is deemed as the atmospheric pressure around the electronic apparatus 1 at the time of taking the frame image. The atmospheric pressure acquired by the atmospheric pressure acquisition unit 370 at the time of taking the frame image is deemed as the atmospheric pressure in the shooting position of the frame image at the time of taking the frame image. Thus, the controller 100 can acquire the atmospheric pressure in the shooting position of the frame image at the time of taking the frame image. In the case where the reproduction supplemental information is the atmospheric pressure in the shooting position of the frame image at the time of taking the frame image, the Y axis direction position of the slider 542 indicates the atmospheric pressure of the shooting position of the frame image at the time of taking the frame image in the reproduced part indicated by the X axis direction position of the slider 542. In other words, the Y coordinate value Y1 of the center 542a of the slider 542 indicates the atmospheric pressure in the shooting position of the frame image at the time of taking the frame image in the reproduced part which is reproduced when the elapsed time for the reproduction coincides with the X coordinate value X1 of the center 542a. The user can easily find the desired part in the video 530 based on the atmospheric pressure indicated by the position of the slider 542. The atmospheric pressure in the shooting position of the frame image at the time of taking the frame image is simply referred to as the “shooting position atmospheric pressure” in some cases hereinafter.

The reproduction supplemental information may be the speed of the electronic apparatus 1 at the time of taking the frame image. In this case, while the video is taken with the camera being used, the controller 100 associates the speed acquired by the speed acquisition unit 350 at the time of taking the frame image of the video and the frame image, and stores them in the non-volatile memory 103b. The speed acquired by the speed acquisition unit 350 at the time of taking the frame image is deemed as the speed of the electronic apparatus 1 at the time of taking the frame image. Thus, the controller 100 can acquire the speed of the electronic apparatus 1 at the time of taking the frame image. In the case where the reproduction supplemental information is the speed of the electronic apparatus 1 at the time of taking the frame image, the Y axis direction position of the slider 542 indicates the speed of the electronic apparatus 1 at the time of taking the frame image in the reproduced part indicated by the X axis direction position of the slider 542. In other words, the Y coordinate value Y1 of the center 542a of the slider 542 indicates the speed of the electronic apparatus 1 at the time of taking the frame image in the reproduced part which is reproduced when the elapsed time for the reproduction coincides with the X coordinate value X1 of the center 542a. The user can easily find the desired part in the video 530 based on the speed indicated by the position of the slider 542.

The reproduction supplemental information may be the temperature of the electronic apparatus 1 at the time of taking the frame image. In this case, while the video is taken with the camera being used, the controller 100 associates the temperature acquired by the temperature acquisition unit 360 at the time of taking the frame image of the video and the frame image, and stores them in the non-volatile memory 103b. The temperature acquired by the temperature acquisition unit 360 at the time of taking the frame image is deemed as the temperature of the electronic apparatus 1 at the time of taking the frame image. Thus, the controller 100 can acquire the temperature of the electronic apparatus 1 at the time of taking the frame image. In the case where the reproduction supplemental information is the temperature of the electronic apparatus 1 at the time of taking the frame image, the Y axis direction position of the slider 542 indicates the temperature of the electronic apparatus 1 at the time of taking the frame image in the reproduced part indicated by the X axis direction position of the slider 542. In other words, the Y coordinate value Y1 of the center 542a of the slider 542 indicates the temperature of the electronic apparatus 1 at the time of taking the frame image in the reproduced part which is reproduced when the elapsed time for the reproduction coincides with the X coordinate value X1 of the center 542a. The user can easily find the desired part in the video 530 based on the temperature indicated by the position of the slider 542.

The reproduction supplemental information may be a distance of the electronic apparatus 1 moving from a position of starting taking the video 530 to a position of taking the frame image of the video 530. In this case, while the video is taken with the camera being used, the controller 100 associates the position of the electronic apparatus 1 acquired by the GPS receiver 150 at the time of taking the frame image of the video and the frame image, and stores them in the non-volatile memory 103b. Then, the controller 100 obtains the distance of the electronic apparatus 1 moving from the position of starting taking the video 530 to the position of taking each frame image based on the position associated with each frame image in the non-volatile memory 103b. The distance of the electronic apparatus 1 moving from the position of starting taking the video 530 to the position of taking the frame image is referred to as the “moving distance at the time of taking the frame image” in some cases hereinafter.

In the case where the reproduction supplemental information is the moving distance at the time of taking the frame image, the Y axis direction position of the slider 542 indicates the moving distance at the time of taking the frame image in the reproduced part indicated by the X axis direction position of the slider 542. In other words, the Y coordinate value Y1 of the center 542a of the slider 542 indicates the moving distance at the time of taking the frame image in the reproduced part which is reproduced when the elapsed time for the reproduction coincides with the X coordinate value X1 of the center 542a. The user can easily find the desired part in the video 530 based on the moving distance at the time of taking the frame image indicated by the position of the slider 542.

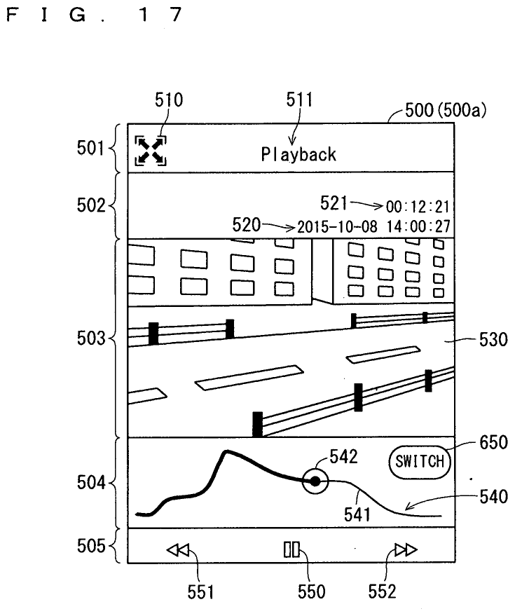

The reproduction supplemental information may be the information whether or not a predetermined event occurs at the time of taking the frame image. FIG. 16 is a drawing showing one example of the reproduction screen 500 in this case. In the case where the reproduction supplemental information is the information whether or not the predetermined event occurs at the time of taking the frame image, the Y axis direction position of the slider 542 indicates whether or not the predetermined event occurs at the time of taking the frame image in the reproduced part indicated by the X axis direction position of the slider 542. The Y coordinate value of the Y axis 582 indicates one in a case where the predetermined event occurs at the time of taking the frame image, and indicates zero in a case where the predetermined event does not occur at the time of taking the frame image. Accordingly, the Y coordinate value Y1 of the center 542a of the slider 542 indicates one in the case where the predetermined event occurs at the time of taking the frame image in the reproduced part which is reproduced when the elapsed time for the reproduction coincides with the X coordinate value X1 of the center 542a, and indicates zero in the case where the predetermined event does not occur at the time of taking the frame image. Accordingly, as shown in FIG. 16, a part of the line-shaped object 541 of the seek bar 540 corresponding to a period when the frame image, in which the predetermined event occurs at the timing of taking the frame image, is reproduced changes in a pulsed form.

In the case where the reproduction supplemental information is the information whether or not the predetermined event occurs at the time of taking the frame image, the controller 100 determines whether or not the predetermined event has occurred while the video 530 is taken. If the controller 100 determines that the predetermined event has occurred while the video 530 is taken, the controller 100 specifies an event occurrence period when the predetermined event occurs. The event occurrence period can be specified based on the time acquired by the RTC 240 while the video 530 is taken. Then, the controller 100 specifies the frame image taken in the event occurrence period. Accordingly, the controller 100 can specify whether or not the predetermined event occurs at the time of taking the frame image for each frame image of the video 530. In a case where the predetermined event has occurred several times while the video 530 is taken, the controller 100 specifies the frame image taken in each event occurrence period for the predetermined event having occurred several times.

Various events are considered as the predetermined event. For example, a trouble of the user of the electronic apparatus 1 is considered as the predetermined event. For example, in a case where the electronic apparatus 1 is fixed to the bicycle 60 of the user 50 as shown in FIG. 5 described above, if the bicycle 60 which the user 50 rides collides with an object and overturns, the direction of the camera lens acquired by the direction acquisition unit 390 rapidly changes. Furthermore, the speed acquired by the speed acquisition unit 350 rapidly decreases, and then indicates zero. The controller 100 determines that the user has a trouble if the direction of the camera lens acquired by the direction acquisition unit 390 drastically changes in a short time and the speed acquired by the speed acquisition unit 350 becomes zero in a short time, for example. If the controller 100 determines that the user has the trouble while the video 530 is taken, the controller 100 specifies a trouble occurrence period in which the trouble occurs. The controller 100 determines that the trouble of the user has been resolved if the speed acquired by the speed acquisition unit 350 gets larger than zero and the direction of the camera lens acquired by the direction acquisition unit 390 becomes stable after the direction of the camera lens acquired by the direction acquisition unit 390 drastically changes in a short time and the speed acquired by the speed acquisition unit 350 becomes zero in a short time, for example. Then, the controller 100 determines the time from when the trouble occurs until when the trouble is resolved to be the trouble occurrence period. If the controller 100 specifies the trouble occurrence period, the controller 100 specifies the frame image taken in the trouble occurrence period in the video 530. Accordingly, the controller 100 can specify whether or not the user has the trouble at the time of taking the frame image for each frame image of the video 530.

An event that the electronic apparatus 1 goes under the water may be the predetermined event. The controller 100 can determine whether or not the electronic apparatus 1 is located in the water based on the detection signal being output from the pressure sensor 250. If the controller 100 determines that the electronic apparatus 1 goes under the water while the video 530 is taken, the controller 100 specifies a period when the electronic apparatus 1 is located in the water. Then, the controller 100 specifies the frame image in the video 530 taken in the period when the electronic apparatus 1 is located in the water. Accordingly, the controller 100 can specify whether or not the electronic apparatus 1 is located in the water at the time of taking the frame image for each frame image of the video 530.

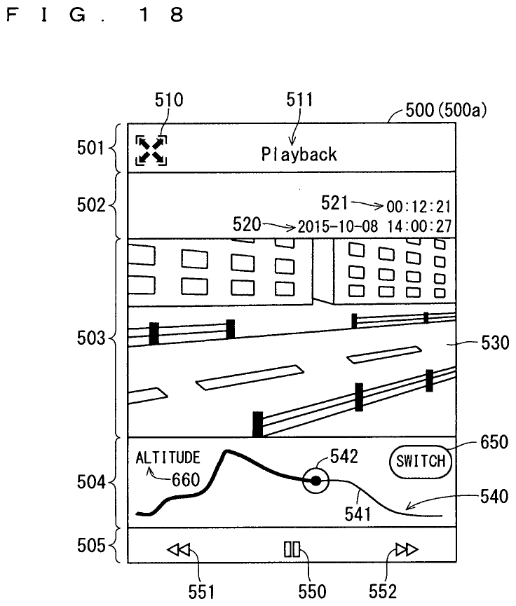

The controller 100 may switch a type of the reproduction supplemental information indicated by the Y axis direction position of the slider 542 in accordance with the instruction from the user. For example, as shown in FIG. 17, a switching button 650 for switching the type of the reproduction supplemental information indicated by the Y axis direction position of the slider 542 is provided in the partial screen 504 of the reproduction screen 500. If the user performs a predetermined operation (a tap operation, for example) on the switching button 650, the controller 100 switches the type of the reproduction supplemental information indicated by the Y axis direction position of the slider 542. In other words, the controller 100 switches the type of the reproduction supplemental information indicated by the Y axis 582.

Considered herein, for example, is a case where the shooting position altitude and the shooting position atmospheric pressure of the frame image are used as the reproduction supplemental information. In a case where the reproduction supplemental information which the Y axis direction position of the slider 542 currently indicates is the shooting position altitude of the frame image, if the user performs the predetermined operation on the switching button 650, the controller 100 switches the reproduction supplemental information indicated by the Y axis direction position of the slider 542 to the shooting position atmospheric pressure of the frame image. Then, if the user performs the predetermined operation on the switching button 650 again, the controller 100 switches the reproduction supplemental information indicated by the Y axis direction position of the slider 542 to the shooting position altitude of the frame image. The controller 100 operates in the similar manner afterward.

Considered is a case where the shooting position altitude of the frame image, the speed of the electronic apparatus 1 at the time of taking the frame image, and the temperature of the electronic apparatus 1 at the time of taking the frame image are used as the reproduction supplemental information. In a case where the reproduction supplemental information which the Y axis direction position of the slider 542 currently indicates is the shooting position altitude of the frame image, if the user performs the predetermined operation on the switching button 650, the controller 100 switches the reproduction supplemental information indicated by the Y axis direction position of the slider 542 to the speed of the electronic apparatus 1 at the time of taking the frame image, for example. Then, if the user performs the predetermined operation on the switching button 650 again, the controller 100 switches the reproduction supplemental information indicated by the Y axis direction position of the slider 542 to the temperature of the electronic apparatus 1 at the time of taking the frame image. Then, if the user performs the predetermined operation on the switching button 650 again, the controller 100 switches the reproduction supplemental information indicated by the Y axis direction position of the slider 542 to the shooting position altitude of the frame image. The controller 100 operates in the similar manner afterward.

Since such a switching button 650 is provided, the user can easily make the electronic apparatus 1 change the type of the reproduction supplemental information indicated by the Y axis direction position of the slider 542.

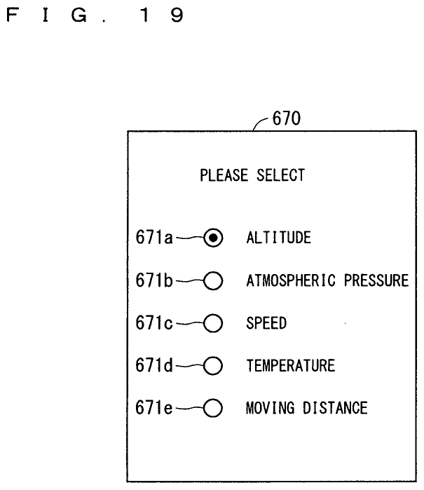

As shown in FIG. 18, the reproduction screen 500 may include specific information 660 for specifying the type of the reproduction supplemental information currently indicated by the Y axis direction position of the slider 542. Even in a case where the type of the reproduction supplemental information indicated by the Y axis direction position of the slider 542 cannot be changed, the reproduction screen 500 may include the specific information 660 as shown in FIG. 18.

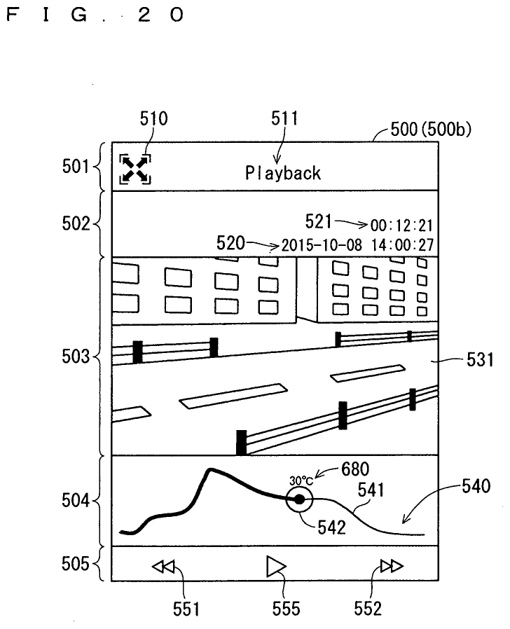

The controller 100 may make the display 120 display a selection screen 670 for the user to select the type of the reproduction supplemental information indicated by the Y axis direction position of the slider 542. FIG. 19 is a drawing showing one example of the selection screen 670. The selection screen 670 includes a plurality of selection buttons 671a to 671e. If the user performs a predetermined operation (a tap operation, for example) on the selection button 671a, the controller 100 sets the reproduction supplemental information indicated by the Y axis direction position of the slider 542 to the shooting position altitude of the frame image. If the user performs a predetermined operation (a tap operation, for example) on the selection button 671b, the controller 100 sets the reproduction supplemental information indicated by the Y axis direction position of the slider 542 to the shooting position atmospheric pressure of the frame image. If the user performs a predetermined operation (a tap operation, for example) on the selection button 671c, the controller 100 sets the reproduction supplemental information indicated by the Y axis direction position of the slider 542 to the speed of the electronic apparatus 1 at the time of taking the frame image. If the user performs a predetermined operation (a tap operation, for example) on the selection button 671d, the controller 100 sets the reproduction supplemental information indicated by the Y axis direction position of the slider 542 to the temperature of the electronic apparatus 1 at the time of taking the frame image. If the user performs a predetermined operation (a tap operation, for example) on the selection button 671e, the controller 100 sets the reproduction supplemental information indicated by the Y axis direction position of the slider 542 to the moving distance at the time of taking the frame image. The display 120 displays the selection screen 670 if the user performs a predetermined operation on the display region 11, for example. The type of the reproduction supplemental information which the user can select is not limited to the example in FIG. 19.

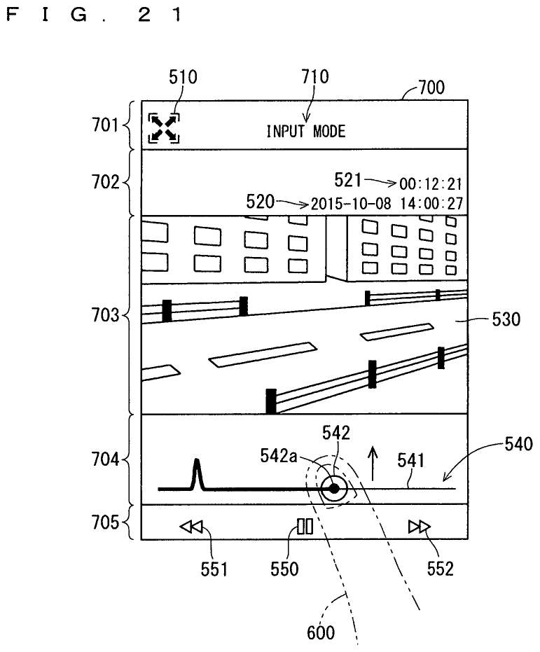

As shown in FIG. 20, the display 120 may display a value 680 of the reproduction supplemental information indicated by the Y axis direction position of the slider 542 near (around) the slider 542. In the example in FIG. 20, the reproduction supplemental information is the temperature of the electronic apparatus 1 at the time of taking the frame image.

### Various Modification Examples

The various modification examples of the electronic apparatus 1 are described below.

### First Modification Example

In the example described above, the electronic apparatus 1 itself acquires the reproduction supplemental information, however the user may input the reproduction supplemental information to the electronic apparatus 1. In the present example, the reproduction supplemental information is a favorite degree of the user on the frame image. The favorite degree is also deemed as a degree of importance or a degree of interest. In the present example, the Y axis direction position of the slider 542 indicates the favorite degree of the user on the frame image in the reproduced part indicated by the X axis direction position of the slider 542. In other words, the Y coordinate value Y1 of the center 542a of the slider 542 indicates the favorite degree of the user on the frame image in the reproduced part which is reproduced when the elapsed time for the reproduction coincides with the X coordinate value X1 of the center 542a. The user can input the favorite degree on the frame image to the electronic apparatus 1 by operating the line-shaped object 541 of the seek bar 540. In the present example, the favorite degree increases as the Y axis coordinate value gets larger.

The electronic apparatus 1 according to the present example has an input mode, as an operation mode, which enables the user to input the favorite degree of the frame image to the electronic apparatus 1. For example, if the long-tap operation is performed on the area other than the seek bar 540 in the partial screen 504 in the reproduction screen 500, the operation mode of the electronic apparatus 1 is switched to the input mode. A condition where the operation mode of the electronic apparatus 1 is switched to the input mode is not limited thereto.

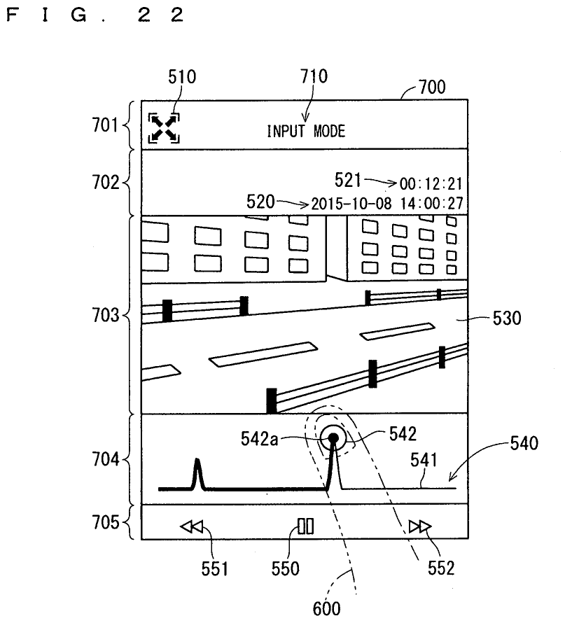

FIG. 21 is a drawing showing one example of an input screen 700 displayed on the display 120 in the case where the electronic apparatus 1 is the input mode. The input screen 700 includes partial screens 701 to 705. The partial screen 701 shows the full-screen display button 510 described above and a character string 710 indicating that the operation mode of the electronic apparatus 1 is the input mode. The partial screens 702 to 705 are the same as the partial screens 502 to 505 described above, respectively. However, a shape of the line-shaped object 541 of the seek bar 540 shown in the partial screen 704 can be changed. The input screen 700 is the same as the reproduction screen 500 except that the character string 710 is shown instead of the character string 511 and the shape of the line-shaped object 541 can be changed.

If the user performs an operation along the Y axis 582 on the line-shaped object 541 displayed on the display 120 (an operation along an upper and lower direction in FIG. 21), a height of a position in the line-shaped object 541 on which the operation has been performed along the Y axis 582 changes in accordance with the operation. That is to say, if the touch panel 140 detects the user operation along the Y axis 582 on the line-shaped object 541, the controller 100 changes the height of the position in the line-shaped object 541 on which the operation has been performed along the Y axis 582 in accordance with the user operation. It is also deemed that if the touch panel 140 detects the user operation along the Y axis 582 on the line-shaped object 541, the controller 100 changes the Y axis coordinate value in the position in the line-shaped object 541 on which the operation has been performed in accordance with the user operation.

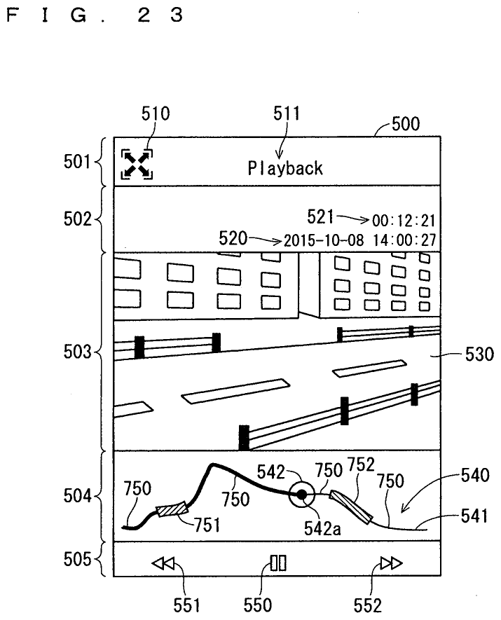

In the present example, if the user performs the slide operation of sliding the operator such as his/her finger along the Y axis 582 with the operator being in contact with a certain position in the line-shaped object 541, the height of the certain position along the Y axis 582 changes in accordance with the slide operation. Assumed as shown in FIG. 21, for example, is a case where the user performs the slide operation of sliding the finger 600 along a plus direction of the Y axis 582 (an upper direction in FIG. 21) with the finger 600 being in contact with a certain position in the line-shaped object 541. In this case, as shown in FIG. 22, the height of the position in the line-shaped object 541, in the Y axis direction, with which the finger 600 comes in contact (the Y coordinate value in the position) increases, and the position coincides with the position in which the slide operation of the finger 600 is finished. At this time, if the user makes the finger 600 come in contact with the line-shaped object 541 as described above, the center 542a of the slider 542 comes to be located in a position where the finger 600 comes in contact in the line-shaped object 541. Accordingly, as shown in FIGS. 21 and 22, the position of the slider 542 changes in accordance with the slide operation of the finger 600.

Assumed is a case where the user performs the slide operation of sliding the finger 600 along a minus direction of the Y axis 582 with the finger 600 being in contact with a certain position in the line-shaped object 541. In this case, the height of the position in the line-shaped object 541, in the Y axis direction, with which the finger 600 comes in contact (the Y coordinate value in the position) decreases, and the position coincides with the position in which the slide operation of the finger 600 is finished.

As described above, the height of the position in the line-shaped object 541 on which the operation has been performed along the Y axis 582 changes in accordance with the operation performed by the user along the Y axis 582 on the line-shaped object 541. In the present example, the Y axis 582 indicates the favorite degree of the frame image, thus the user can, by performing the operation along the Y axis 582 on the line-shaped object 541 with the operator such as his/her finger, input the favorite degree of the frame image corresponding to the position in the line-shaped object 541 on which the operation is performed to the electronic apparatus 1. For example, the user performs the slide operation of sliding the finger 600 with reference to the frame image shown in the partial screen 703 when the finger 600 comes in contact with the certain position in the line-shaped object 541 to make the electronic apparatus 1 change the height of the position in the Y axis direction. Accordingly, the frame image corresponding to the certain position, that is to say, the favorite degree of the frame image shown in the partial screen 703 is adjusted.

For example, if the long-tap operation is performed on the area other than the seek bar 540 in the partial screen 704 in the input screen 700, the input mode is released and the display 120 displays the reproduction screen 500. The condition where the input mode is released is not limited thereto.

Even if the reproduction supplemental information is other than the favorite degree of the frame image, the user can input the reproduction supplemental information to the electronic apparatus 1 by performing the operation in the similar manner on the line-shaped object 541.

### Second Modification Example

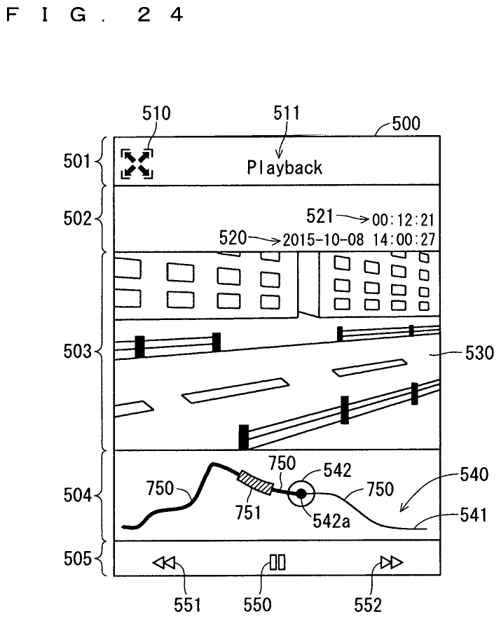

FIG. 23 is a drawing showing one example of the reproduction screen 500 according to the present modification example. In the present modification example, another information different from the reproduction supplemental information indicated by the Y axis direction position of the line-shaped object 541 is indicated by color-coding the line-shaped object 541 of the seek bar 540. This another information is referred to as the “second reproduction supplemental information” hereinafter. The reproduction supplemental information indicated by the Y axis direction position of the line-shaped object 541 is referred to as the “first reproduction supplemental information”.

In the present example, the line-shaped object 541 is color-coded in accordance with the second reproduction supplemental information according to the reproduced part of the video 530. Then, the second reproduction supplemental information according to the reproduced part of the video 530 is indicated by a color of a part in which the slider 542, whose X axis direction position in the line-shaped object 541 indicates the reproduced part, is located. The second reproduction supplemental information according to the reproduced part of the video 530 is other than information indicating whether or not the reproduced part has been reproduced. This point is specifically described hereinafter.

The first reproduction supplemental information is the shooting position altitude of the frame image, for example. The second reproduction supplemental information is information that a predetermined type of value regarding the reproduced part falls within a predetermined range, for example.

In the present example, two types of information are used as the second reproduction supplemental information, for example. First information which is initial information is information that the predetermined type of value regarding the reproduced part is equal to or larger than a first predetermined value, for example. Second information which is secondary information is information that the predetermined type of value regarding the reproduced part is equal to or smaller than a second predetermined value, for example. In the present example, the speed at the time of taking the frame image is adopted as the predetermined type of value. Accordingly, in the present example, the first information is the information that the speed at the time of taking the frame image is equal to or larger than the first predetermined value. The second information is the information that the speed at the time of taking the frame image is equal to or smaller than the second predetermined value. The first predetermined value is set to a value larger than the second predetermined value, for example. The first predetermined value may be the same as the second predetermined value.

The line-shaped object 541 of the seek bar 540 is color-coded to have three colors. For example, the line-shaped object 541 has a blue part 750, a red part 751, and a green part 752. The line-shaped object 541 is made up of the blue part 750 except for the red part 751 and the green part 752. The red part 751 corresponds to the first information. The green part 752 corresponds to the second information. The blue part 750 does not correspond to the second reproduction supplemental information. The red part 751 and the green part 752 are thicker than the blue part 750. In FIG. 23, the red color is expressed by an upward-sloping line and the green color is expressed by a downward-sloping line for convenience of description. The red part 751 and the green part 752 may have the same thickness as the blue part 750.

The red part 751 of the line-shaped object 541 means that the speed at the time of taking the frame image in the reproduced part corresponding to the red part 751 is equal to or larger than the first predetermined value. That is to say, the speed at the time of taking the frame image in the reproduced part indicated by the X axis direction position of the slider 542, in which the position of the center 542a is located on the red part 751, is equal to or larger than the first predetermined value.

The green part 752 of the line-shaped object 541 means that the speed at the time of taking the frame image in the reproduced part corresponding to the green part 752 is equal to or smaller than the second predetermined value. That is to say, the speed at the time of taking the frame image in the reproduced part indicated by the X axis direction position of the slider 542, in which the position of the center 542a is located on the green part 752, is equal to or smaller than the second predetermined value.

As described above, in the present modification example, the second reproduction supplemental information according to the reproduced part of the video 530 is indicated by a color of a part in which the slider 542, whose X axis direction position in the line-shaped object 541 indicates the reproduced part, is located. Thus, the user can easily find the desired part in the video 530 based on the second reproduction supplemental information.

The types of colors used for color-coding the line-shaped object 541 are not limited to the example described above. Also in the present example, the reproduction supplemental information may be the information other than the shooting position altitude of the frame image. The first reproduction supplemental information is the temperature at the time of taking the frame image, for example. The second reproduction supplemental information is not limited to the example described above. The modification example of the second reproduction supplemental information is described below.

The second information needs not be adopted as the second reproduction supplemental information. In this case, the green part 752 becomes the blue part 750. The first information needs not be adopted as the second reproduction supplemental information. In this case, the red part 751 becomes the blue part 750.

The first information may be information that the predetermined type of value regarding the reproduced part is larger than the first predetermined value. The second information may be information that the predetermined type of value regarding the reproduced part is smaller than the second predetermined value.

Third information that the predetermined type of value regarding the reproduced part is equal to or larger than a third predetermined value and equal to or smaller than a fourth predetermined value may be adopted as the second reproduction supplemental information. The fourth predetermined value is set to a value larger than the third predetermined value. In the case where the third information is adopted as the second reproduction supplemental information, only the first information in the first and second information may be adopted as the second reproduction supplemental information. In this case, the fourth predetermined value is set to be equal to or smaller than the first predetermined value. In the case where the third information is adopted as the second reproduction supplemental information, only the second information in the first and second information may be adopted as the second reproduction supplemental information. In this case, the third predetermined value is set to be equal to or larger than the second predetermined value. In the case where the third information is adopted as the second reproduction supplemental information, the first and second information may be adopted as the second reproduction supplemental information. In this case, the first predetermined value is set to be larger than the second predetermined value, the third predetermined value is set to be equal to or larger than the second predetermined value, and the fourth predetermined value is set to be equal to or smaller than the first predetermined value. The third information may be information that the predetermined type of value regarding the reproduced part is larger than the third predetermined value and equal to or smaller than the fourth predetermined value. The third information may be information that the predetermined type of value regarding the reproduced part is equal to or larger than the third predetermined value and smaller than the fourth predetermined value. The third information may be information that the predetermined type of value regarding the reproduced part is larger than the third predetermined value and smaller than the fourth predetermined value.

The predetermined type of value regarding the second reproduction supplemental information may be a value other than the speed at the time of taking the frame image. For example, the predetermined type of value may be the temperature at the time of taking the frame image, the shooting position altitude of the frame image, or the shooting position atmospheric pressure of the frame image. The first to fourth predetermined values are appropriately determined by the type of the predetermined type of value.

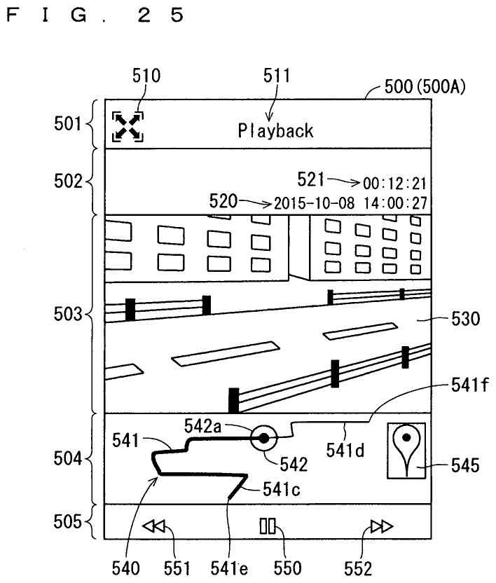

The second reproduction supplemental information may be information that an event occurs at the time of taking the frame image. FIG. 24 is a drawing showing one example of the reproduction screen 500 in this case. In the example in FIG. 24, the line-shaped object 541 has the blue part 750 and the red part 751. The line-shaped object 541 is made up of the blue part 750 except for the red part 751. The red part 751 corresponds to the second reproduction supplemental information. The blue part 750 does not correspond to the second reproduction supplemental information.

The red part 751 means that a predetermined event occurs at the time of taking the frame image in the reproduced part corresponding to the red part 751. That is to say, the predetermined event occurs at the time of taking the frame image in the reproduced part indicated by the X axis direction position of the slider 542, in which the position of the center 542a is located on the red part 751. For example, the trouble of the user of the electronic apparatus 1 is considered as the predetermined event as described. The event that the electronic apparatus 1 goes under the water is considered as the predetermined event. The predetermined event is not limited thereto.

The type of the second reproduction supplemental information can be changed by the user as is the case where the type of the first reproduction supplemental information can be changed by the user. In this case, for example, a switching button similar to the switching button 650 shown in FIG. 18 described above, that is to say, a switching button for switching the type of the second reproduction supplemental information may be provided in the reproduction screen 500. The display 120 may display a selection screen similar to the selection screen 670 shown in FIG. 19, that is to say, a selection screen for the user to select the type of the second reproduction supplemental information.

### Third Modification Example

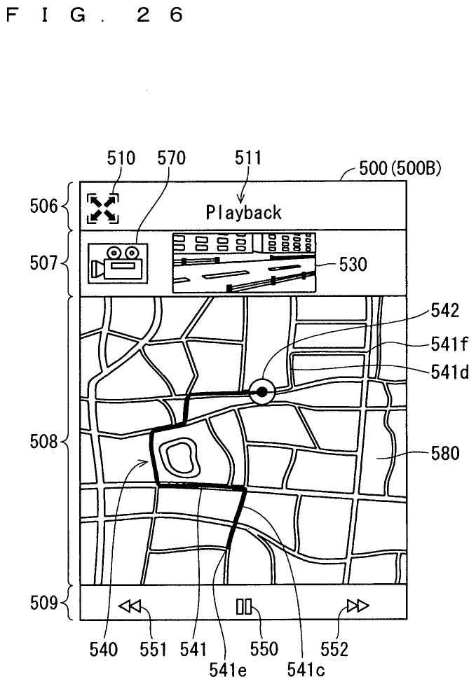

FIG. 25 is a drawing showing one example of the reproduction screen 500 according to the present modification example. In the seek bar 540 according to the present modification example, the line-shaped object 541 has a curved shape in accordance with a route along which the electronic apparatus 1 moves while taking the video 530. The route along which the electronic apparatus 1 moves while taking the video 530 is simply referred to as the “moving route” hereinafter. In the present modification example, the reproduction supplemental information according to the reproduced part indicated by the position of the slider 542 on the line-shaped object 541 indicates the position of the electronic apparatus 1 on the moving route in the case where the electronic apparatus 1 takes the frame image in the reproduced part. The position of the slider 542 on the line-shaped object 541 indicates the reproduced part, and also indicates the position of the electronic apparatus 1 on the moving route in the case where the electronic apparatus 1 takes the frame image in the reproduced part. Specifically, the position of the center 542a the slider 542 on the line-shaped object 541 indicates the reproduced part, and also indicates the position of the electronic apparatus 1 on the moving route in the case where the electronic apparatus 1 takes the frame image in the reproduced part. The frame image taken in the position on the moving route specified by the position of the center 542a of the slider 542 on the line-shaped object 541 is reproduced in the display 120.

One end 541e of the line-shaped object 541 corresponds to a starting point of the moving route. Accordingly, if the center 542a of the slider 542 is located in the one end 542e, the re0156produced part of the video 530 falls on an initial frame image. That is to say, if the center 542a of the slider 542 is located in the one end 542e, the frame image taken in the starting point of the moving route is reproduced. Other end 541f of the line-shaped object 541 corresponds to an ending point of the moving route. Accordingly, if the center 542a of the slider 542 is located in the other end 542f, the reproduced part of the video 530 falls on a last frame image. That is to say, if the center 542a of the slider 542 is located in the other end 542f, the frame image taken in the ending point of the moving route is reproduced. A length of the line-shaped object 541 is deemed to indicate a total moving distance that the electronic apparatus 1 has moved from start to finish of taking the video 530. A moving direction of the slider 542 is deemed to indicate a moving direction of the electronic apparatus 1, in other words, a traveling direction of the user.

The display 120 according to the present modification example has first and second display modes as a display mode. The display 120 switches the display mode in accordance with an instruction from the user. In the first display mode, the seek bar 540 is displayed on a map so that the line-shaped object 541 coincides with the moving route on the map. In the meanwhile, in the second display mode, the seek bar 540 is displayed without the display of the map, and the video 530 is displayed to be larger than that in the first display mode. The reproduction screen 500 shown in FIG. 25 is a screen displayed on the display 120 in the second display mode. The reproduction screen 500 in the second display mode is referred to as the “reproduction screen 500A” in some cases.

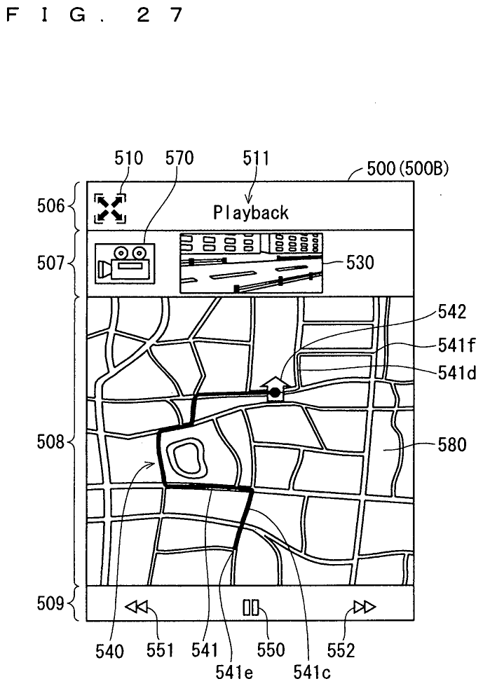

The partial screen 504 of the reproduction screen 500A shows a switching button 545 for switching the display mode of the display 120 from the second display mode to the first display mode. If the user performs a predetermined operation (a tap operation, for example) on the switching button 545, the display mode of the display 120 changes from the second display mode to the first display mode. FIG. 26 is a drawing showing one example of the reproduction screen 500 displayed on the display 120 in the first display mode. The reproduction screen 500 in the first display mode is referred to as the “reproduction screen 500B” in some cases.

The reproduction screen 500B includes partial screens 506 to 509. The partial screens 506 and 509 are the same as the partial screens 501 and 505 of the reproduction screen 500A.

The partial screen 507 shows a switching button 570 for switching the display mode of the display 120 from the first display mode to the second display mode. If the user performs a predetermined operation (a tap operation, for example) on the switching button 570, the display mode of the display 120 changes from the first display mode to the second display mode.

The partial screen 507 further shows the video 530 being reproduced. As shown in FIGS. 25 and 26, in the reproduction screen 500A in the second display mode, the video 530 being reproduced is displayed to be larger than that in the reproduction screen 500B in the first display mode.

The partial screen 508 shows a map 580 including the moving route. The partial screen 508 shows the seek bar 540 on the map 580 so that the line-shaped object 541 coincides with the moving route on the map 580. Accordingly, the user can recognize how the electronic apparatus 1 has moved on the map 580 at the time of taking the video 530. In other words, the user can recognize how the user has moved on the map 580 at the time of taking the video 530.

FIG. 26 shows the reproduction screen 500B during the reproduction of the video. The reproduction screen 500B in which the reproduction of the video is stopped shows the play button 555 instead of the pause button 550 as shown in FIG. 10 described above, and the partial screen 507 shows the frame image in a part in which the reproduction is stopped.

The display mode of the display 120 may include only the first display mode in the first and second display modes. That is to say, the reproduction screen 500A shown in FIG. 25 needs not be displayed. In this case, the display 120 may display the video 530 (or the frame image in the part in which the reproduction is stopped) to be larger than the map 580, differing from the example in FIG. 26.

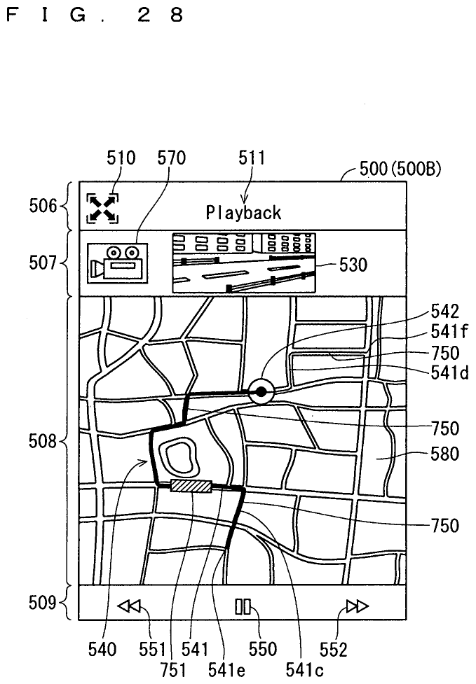

The slider 542 may indicate the direction of the camera lens when the electronic apparatus 1 takes the frame image in the reproduced part indicated by the position of the slider 542. FIG. 27 is a drawing showing one example of the reproduction screen 500B in this case. In the reproduction screen 500B shown in FIG. 27, an outline of the slider 542 has a shape of an arrow. A direction indicated by the arrow forming the outline of the slider 542 indicates the direction of the camera lens when the electronic apparatus 1 takes the frame image in the reproduced part indicated by the position of the slider 542. In the example in FIG. 27, a direction on an immediately upper side of the map is a northward direction, thus the direction of the camera lens is the northward direction. That is to say, the user takes the video with the lens of the camera being used directed to a north side. In the case where the lens of the camera being used faces the traveling direction of the user as shown in FIG. 5 described above, the arrow forming the outline of the slider 542 always indicates the moving direction of the slider 542. The outline of the slider 542 has a shape of an arrow also in the reproduction screen 500A, and the arrow indicates the direction of the camera lens.

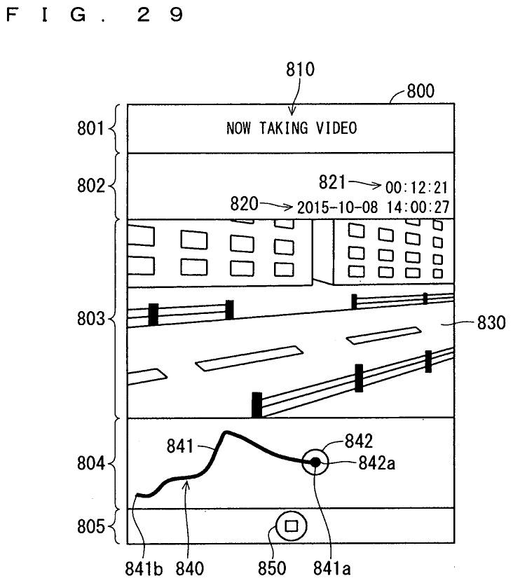

As shown in FIG. 28, the line-shaped object 541 may be color-coded also in the present modification example in the manner similar to the second medication example described above. In the example in FIG. 28, the line-shaped object 541 includes the blue part 750 which does not correspond to the second reproduction supplemental information and the red part 751 which corresponds to the second reproduction supplemental information. The line-shaped object 541 is color-coded also in the reproduction screen 500A in the similar manner.

### Fourth Modification Example

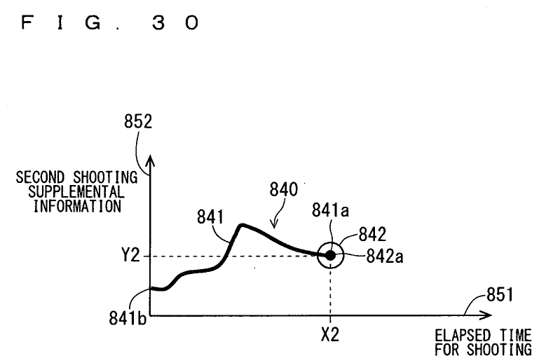

The display 120 may display a display object having a shape similar to the shape of the seek bar 540 when the camera being used takes the video. FIG. 29 is a drawing showing an example of a shooting screen 800 displayed at the time of video shooting in the electronic apparatus 1 according to the present modification example. The shooting screen 800 is different from the screen shown in FIG. 8 described above.

The shooting screen 800 includes partial screens 801 to 805. The partial screens 801 to 805 are arranged in this order from above in the shooting screen 800. The partial screen 801 shows a character string 810 indicating that the video is being taken. The partial screen 802 shows a current shooting date and time 820 of the video and an elapsed time for a video shooting 821. The partial screen 803 shows a video 830 being taken. The partial screen 803 sequentially shows the frame images taken with the camera being used. The partial screen 805 shows a shooting finish button 850 for finishing the shooting of the video 830. If the user performs a predetermined operation (a tap operation, for example) on the shooting finish button 850, the shooting of the video 830 is finished. The predetermined operation performed on the shooting finish button 850 falls under the finish instruction operation in Step s7 described above. The partial screen 804 shows a shooting indicator 840 indicating how the shooting of the video 830 proceeds.

### Details of Shooting Indicator

The shooting indicator 840 includes a line-shaped object 841 which becomes elongated in accordance with the progress of the shooting of the video 830. A tip 841a of the line-shaped object 841 indicates a mark 842. The mark 842 indicates a position of the tip 841a of the line-shaped object 841. A position of a center 842a of the mark 842 coincides with the position of the tip 841a of the line-shaped object 841. The line-shaped object 841 has a curved shape in accordance with predetermined information according to the frame image included in a part in which the shooting of the video 830, which is being taken, is finished. This predetermined information is referred to as the “second shooting supplemental information” to separate from the shooting supplemental information described above. The position of the tip 841a of the line-shaped object 841 indicates how the shooting of the video 830 proceeds and the second shooting supplemental information in accordance with the current shooting frame image. In other words, the position of the mark 842 indicates how the shooting of the video 830 proceeds and the second shooting supplemental information in accordance with the current shooting frame image. In still other words, the position of the tip 841a of the line-shaped object 841 indicates how the shooting of the video 830 proceeds and the second shooting supplemental information in accordance with the frame image currently displayed in the partial screen 803.

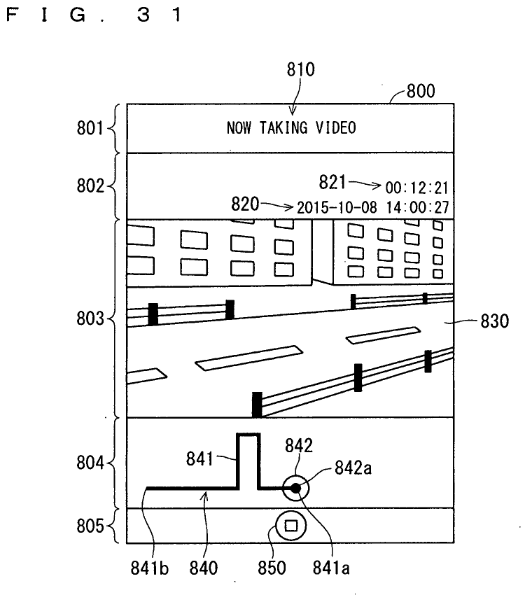

FIG. 30 is a drawing for describing one example of the shooting indicator 840. As shown in FIG. 30, the line-shaped object 841 is expressed in a two-dimensional graph in which a first axis 851 indicates an elapsed time for the shooting of the video 830 and a second axis 852 perpendicular to the first axis 851 indicates the second shooting supplemental information. The graph is continually updated in accordance with the elapsed time for the shooting. The first axis 851 is referred to as the “X axis 851” and the second axis 852 is referred to as the “Y axis 852” hereinafter for convenience of description. In the present modification example, a direction along the X axis 851 is referred to as the “X axis direction”, and a direction along the Y axis 852 is referred to as the “Y axis direction”.

The X coordinate value X2 on the tip 841a of the line-shaped object 841 indicates the elapsed time for the shooting. Thus, the position of the tip 841a of the line-shaped object 841 in the X axis direction is deemed to indicate how the shooting of the video 830 proceeds. As the elapsed time for the shooting increases, the X coordinate value X2 on the tip 841a of the line-shaped object 841 gets large. In other words, as the elapsed time for the shooting increases, the length of the line-shaped object 841 in the X axis direction gets large. An X coordinate value of a fixed end 841b located on an opposite side of the tip 841a in the line-shaped object 841 indicates zero.

In the meanwhile, the position of the tip 841a of the line-shaped object 841 in the Y axis direction indicates the second shooting supplemental information in accordance with the current shooting frame image. That is to say, the Y coordinate value Y2 of the tip 841a of the line-shaped object 841 indicates the second shooting supplemental information in accordance with the current shooting frame image. The Y coordinate value in a certain position in the line-shaped object 841 indicates the second shooting supplemental information in accordance with the frame image taken when the shooting of the video 830 has proceeded for a period of time indicated by the X coordinate value in the certain position. The Y coordinate value of the fixed end (the starting point) 841b of the line-shaped object 841 indicates the second shooting supplemental information in accordance with the frame image which has taken first.

Information similar to the reproduction supplemental information described above, for example, can be adopted as the second shooting supplemental information. Adopted as the second shooting supplemental information is, for example, an altitude of a shooting position of a frame image of the video 830 at the time of taking the frame image (a shooting position altitude of the frame image). In other words, adopted as the second shooting supplemental information is an altitude acquired by the altitude acquisition unit 380 at the time of taking the frame image.

In the case where the shooting position altitude of the frame image is adopted as the second shooting supplemental information, the Y axis 852 indicates the shooting position altitude of the frame image. The position of the tip 841a of the line-shaped object 841 in the Y axis direction indicates the shooting position altitude of the current shooting frame image. That is to say, the Y coordinate value Y2 of the tip 841a of the line-shaped object 841 indicates the shooting position altitude of the current shooting frame image. In the present modification example, the shooting position altitude indicated by the Y axis 852 increases toward the plus direction of the Y axis 852. The X axis 851 and the Y axis 852 shown in FIG. 30 are not shown in the shooting screen 800.

As described above, in the shooting indicator 840, the position of the tip 841a of the line-shaped object 841 indicates how the shooting of the video proceeds and the second shooting supplemental information in accordance with the current shooting frame image. Thus, the user can easily recognize how the shooting of the video proceeds and the second shooting supplemental information in accordance with the current shooting frame image.

The second shooting supplemental information may be the information other than the shooting position altitude of the frame image. The second shooting supplemental information may be the shooting position atmospheric pressure of the frame image, for example. In this case, the position of the tip 841a of the line-shaped object 841 indicates how the shooting of the video proceeds and the shooting position atmospheric pressure of the current shooting frame image. The second shooting supplemental information may be the speed of the electronic apparatus 1 at the time of taking the frame image, the temperature of the electronic apparatus 1 at the time of taking the frame image, or the moving distance at the time of taking the frame image.

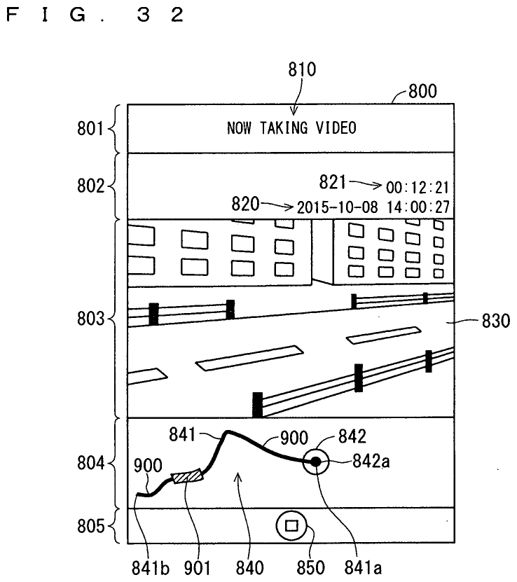

The second shooting supplemental information may be the information whether or not a predetermined event occurs at the time of taking the frame image. FIG. 31 is a drawing showing one example of the shooting screen 800 in this case. If the second shooting supplemental information is the information whether or not the predetermined event occurs at the time of taking the frame image, the position of the tip 841a of the line-shaped object 841 in the Y axis direction indicates whether or not the predetermined event occurs at the time of taking the current shooting frame image. That is to say, the position of the tip 841a of the line-shaped object 841 in the Y axis direction indicates whether or not the predetermined event currently occurs. The Y coordinate value of the Y axis 582 indicates one in a case where the predetermined event does not occur at the time of taking the frame image, and indicates zero in a case where the predetermined event occurs at the time of taking the frame image. Accordingly, the Y coordinate value Y2 of the tip 841a of the line-shaped object 841 indicates one in a case where the predetermined event currently occurs, and indicates zero in a case where the predetermined event does not currently occur. For example, the trouble of the user of the electronic apparatus 1 is considered as the predetermined event as described above. An event that the electronic apparatus 1 goes under the water may be the predetermined event.

In a manner similar to the switching of the type of the reproduction supplemental information indicated by the Y axis direction position of the slider 542, the controller 100 may switch the type of the second shooting supplemental information indicated by the position of the tip 841a of the line-shaped object 841 in the Y axis direction in accordance with the instruction from the user. In this case, for example, a switching button similar to the switching button 650 shown in FIG. 17 described above, that is to say, a switching button for switching the type of the second shooting supplemental information indicated by the position of the tip 841a of the line-shaped object 841 in the Y axis direction is shown in the partial screen 804, for example, of the shooting screen 800. If the user performs a predetermined operation (a tap operation, for example) on the switching button, the controller 100 switches the type of the second shooting supplemental information indicated by the position of the tip 841a of the line-shaped object 841 in the Y axis direction.

The shooting screen 800 may include specific information similar to the specific information 660 shown in FIG. 18 described above, that is to say, specific information for specifying the type of the second shooting supplemental information indicated by the position of the tip 841a of the line-shaped object 841 in the Y axis direction.

The controller 100 may make the display 120 display a selection screen similar to the selection screen 670 shown in FIG. 19 described above, that is to say, a selection screen for the user to select the type of the second shooting supplemental information indicated by the position of the tip 841a of the line-shaped object 841 in the Y axis direction.

The display 120 may display a value similar to the value 680 of the reproduction supplemental information shown in FIG. 20 described above, that is to say, a value of the second shooting supplemental information indicated by the position of the tip 841a of the line-shaped object 841 in the Y axis direction near (around) the tip 841a.

### Fifth Modification Example

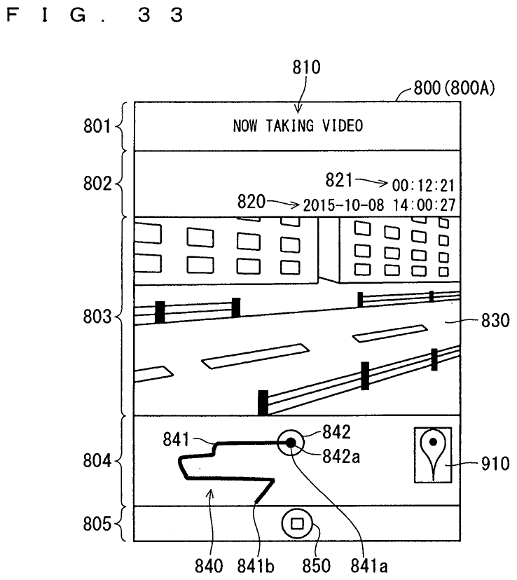

In the electronic apparatus 1 according to the fourth modification example described above, another information different from the second shooting supplemental information indicated by the position of the tip 841a of the line-shaped object 841 in the Y axis direction may be indicated by color-coding the line-shaped object 841 in a manner similar to the second modification example described above. This another information is referred to as the “third shooting supplemental information” hereinafter. FIG. 32 is a drawing showing one example of the shooting screen 800 in this case.

The line-shaped object 841 shown in FIG. 32 is color-coded in accordance with the third shooting supplemental information according to the shooting frame image taken at the time of taking the video 830. In the example in FIG. 32, the line-shaped object 841 includes a blue part 900 and a red part 901. The red part 901 corresponds to the third shooting supplemental information, and the blue part 900 does not correspond to the third shooting supplemental information. The third shooting supplemental information according to the shooting frame image is indicated by a color of a part of the line-shaped object 841 corresponding to the shooting frame image. That is to say, the third shooting supplemental information according to the shooting frame image taken when a certain period of time has elapsed since the shooting of the video 830 has been started is indicated by a color of a part of the line-shaped object 841 in which the X coordinate value indicates the certain period of time.

Information similar to the second reproduction supplemental information described above, for example, can be adopted as the third shooting supplemental information. Information that the speed at the time of taking the frame image is equal to or larger than the first predetermined value, for example, can be adopted as the third shooting supplemental information. In this case, the red part 901 means that the speed at the time of taking the shooting frame image corresponding to the red part 901 is equal to or larger than the first predetermined value. If the speed at the time of taking the current shooting frame image is equal to or larger than the first predetermined value, the tip 841a of the line-shaped object 841 becomes the red part 901. That is to say, if the current speed of the electronic apparatus 1 is equal to or larger than the first predetermined value, the tip 841a of the line-shaped object 841 becomes the red part 901. In a case where a certain frame image in the video 830 is taken when a certain period time has elapsed since the shooting of the video 830 has been started, if a color of a part of the line-shaped object 841 in which the X coordinate value indicates the certain period of time is the red color, the speed at the time of taking the certain frame image is equal to or larger than the first predetermined value.

As described above, in the present modification example, the third shooting supplemental information according to the shooting frame image is indicated by a color of a part corresponding to the shooting frame image in the line-shaped object 841. Accordingly, the user can easily recognize how the shooting of the video 830 proceeds, the second shooting supplemental information, and the third shooting supplemental information by referring to the shooting indicator 840.

### Sixth Modification Example

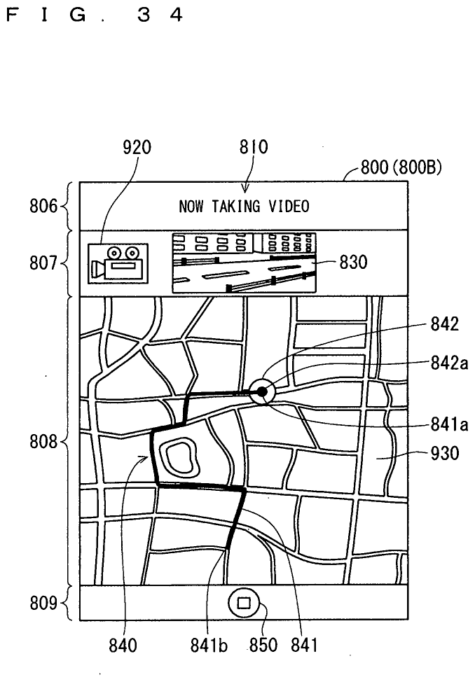

In the electronic apparatus 1 according to the fourth and fifth modification examples described above, the line-shaped object 841 may have a curved shape in accordance with a route along which the electronic apparatus 1 moves while taking the video 830 as is the case of the third modification example described above. FIG. 33 is a drawing showing one example of the shooting screen 800 in this case.

In the shooting indicator 840 shown in FIG. 33, the line-shaped object 841 has a curved shape in accordance with the route along which the electronic apparatus 1 moves while taking the video 830. The tip 841a of the line-shaped object 841 indicates how the shooting of the video 830 proceeds and the current position of the electronic apparatus 1. The fixed end 841b of the line-shaped object 841 indicates the position of the electronic apparatus 1 when the shooting of the video 830 is started. A length of the line-shaped object 841 is deemed to indicate a moving distance that the electronic apparatus 1 moves from the start of taking the video 830 to the present time. A direction in which the tip 841a of the line-shaped object 841 extends is deemed to indicate a moving direction of the electronic apparatus 1, in other words, a traveling direction of the user.

The display 120 according to the present modification example has third and fourth display modes as a display mode. The display 120 switches the display mode in accordance with an instruction from the user. In the third display mode, the shooting indicator 840 is displayed on a map so that the line-shaped object 841 coincides with the moving route on the map. In the meanwhile, in the fourth display mode, the shooting indicator 840 is displayed without the display of the map, and the video 830 is displayed to be larger than that in the third display mode. The shooting screen 800 shown in FIG. 33 is a screen displayed on the display 120 in the fourth display mode. The shooting screen 800 in the fourth display mode is referred to as the “shooting screen 800A”.

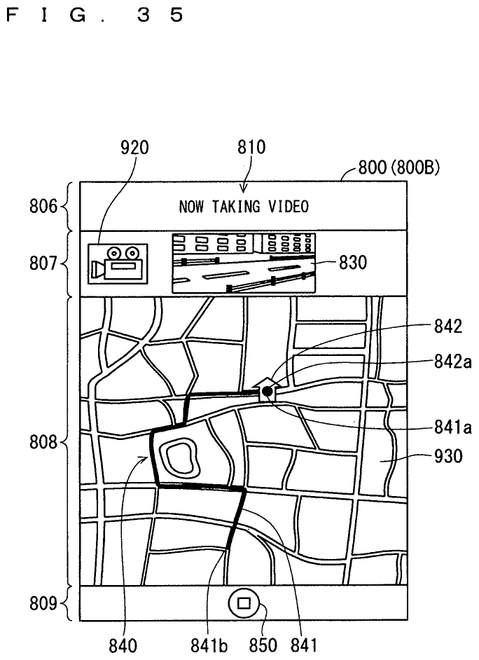

The partial screen 804 of the shooting screen 800A shows a switching button 910 for switching the display mode of the display 120 from the fourth display mode to the third display mode. If the user performs a predetermined operation (a tap operation, for example) on the switching button 910, the display mode of the display 120 changes from the fourth display mode to the third display mode. FIG. 34 is a drawing showing one example of the shooting screen 800 displayed on the display 120 in the third display mode. The shooting screen 800 is referred to as the “shooting screen 800B”.

The shooting screen 800B includes partial screens 806 to 809. The partial screens 806 and 809 are the same as the partial screens 801 and 805 of the shooting screen 800A.

The partial screen 807 shows a switching button 920 for switching the display mode of the display 120 from the third display mode to the fourth display mode. If the user performs a predetermined operation (a tap operation, for example) on the switching button 920, the display mode of the display 120 changes from the third display mode to the fourth display mode.

The partial screen 807 further shows the video 830 being taken. As shown in FIGS. 33 and 34, in the shooting screen 800A in the fourth display mode, the video 830 being taken is displayed to be larger than that in the shooting screen 800B in the third display mode.

The partial screen 808 shows a map 930 including the moving route. The partial screen 808 shows the shooting indicator 840 on the map 930 so that the line-shaped object 841 coincides with the moving route on the map 930. Accordingly, the user can recognize how the electronic apparatus 1 has moved on the map 930 at the time of taking the video 830. In other words, the user can recognize how the user has moved on the map 930 at the time of taking the video 830.

The display mode of the display 120 may include only the third display mode in the third and fourth display modes. That is to say, the shooting screen 800A shown in FIG. 33 needs not be displayed. In this case, the display 120 may display the video 830 to be larger than the map 930, differing from the example in FIG. 34.

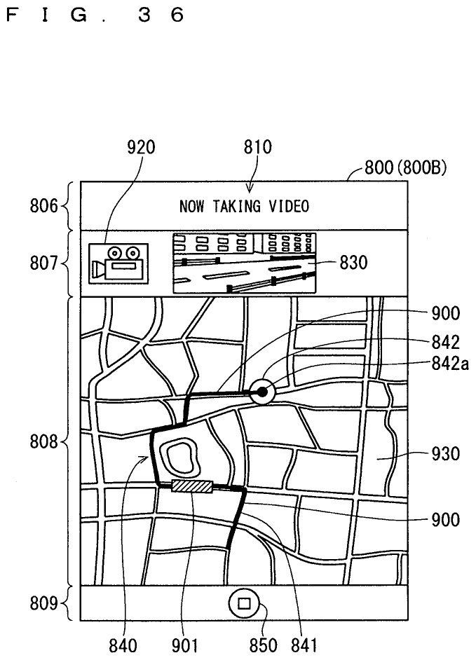

The mark 842 indicating the tip 841a of the line-shaped object 841 may indicate the current direction of the camera lens. FIG. 35 is a drawing showing one example of the shooting screen 800B in this case. In the shooting screen 800B shown in FIG. 35, an outline of the mark 842 has a shape of an arrow. A direction indicated by the arrow forming the outline of the mark 842 indicates the current direction of the camera lens. In the example in FIG. 35, a direction on an immediately upper side of the map is a northward direction, thus the direction of the camera lens is the northward direction. That is to say, the user currently takes the video with the lens of the camera being used directed to a north side. The outline of the mark 842 has a shape of an arrow also in the shooting screen 800A, and the arrow indicates the current direction of the camera lens.

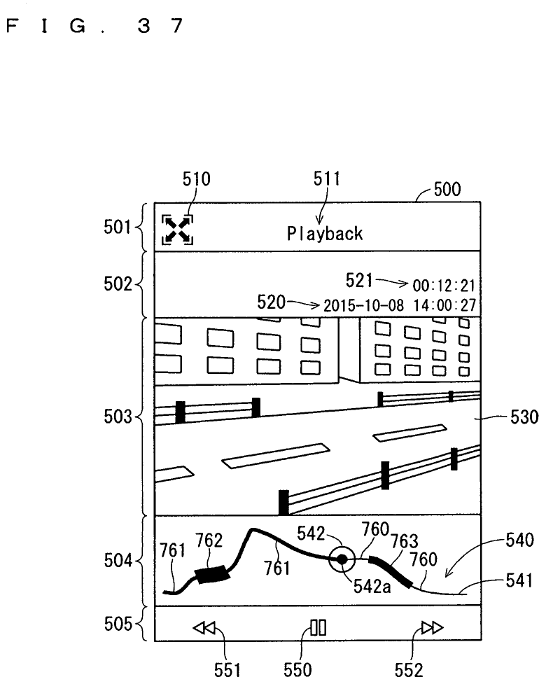

As shown in FIG. 36, the line-shaped object 841 may be color-coded in the manner similar to the fifth modification example described above. In the example in FIG. 36, the line-shaped object 841 includes the blue part 900 which does not correspond to the third shooting supplemental information and the red part 901 which corresponds to the third shooting supplemental information. The line-shaped object 841 is color-coded also in the shooting screen 800A in the similar manner.

### Another Modification Example

In the second and fifth modification examples described above, for example, the line-shaped object 541 and the line-shaped object 841 are indicated by plural types of lines whose colors are different from each other, however, they may be indicated by plural type of lines whose thicknesses are different from each other.

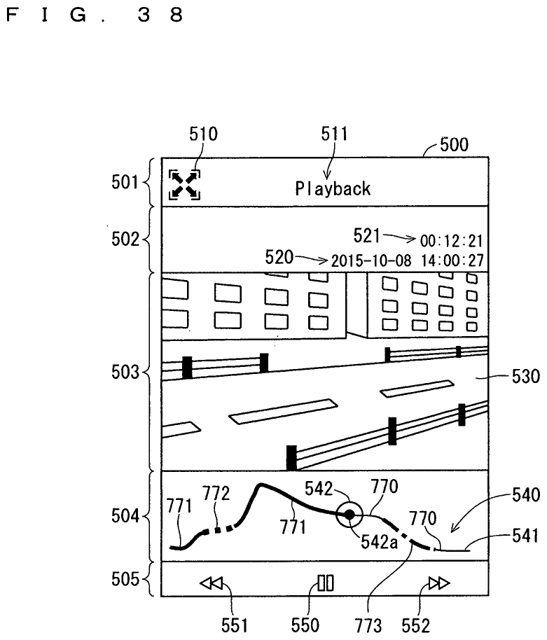

FIG. 37 is a drawing showing the line-shaped object 541 indicated by the plural types of lines whose thicknesses are different from each other in the example in FIG. 23 described above. In the example in FIG. 37, the line-shaped object 541 is indicated by the four types of lines whose thicknesses are different from each other. In the line-shaped object 541, a first part 760 whose thickness is the smallest corresponds to a part in which the reproduction of the video 530 is not yet finished. In the line-shaped object 541, a second part 761 whose thickness is the second smallest corresponds to a part in which the reproduction of the video 530 is finished. In the line-shaped object 541, a third part 762 whose thickness is the largest corresponds to first information that the predetermined type of value regarding the reproduced part is equal to or larger than the first predetermined value and also corresponds to a part in which the reproduction of the video 530 is finished. In the line-shaped object 541, a fourth part 763 whose thickness is the second largest corresponds to second information that the predetermined type of value regarding the reproduced part is equal to or smaller than the second predetermined value and a part in which the reproduction of the video 530 is not yet finished.

Each of the line-shaped object 541 and the line-shaped object 841 may be indicated by the plural types of lines including a discontinuous line. FIG. 38 is a drawing showing the line-shaped object 541 indicated by the plural types of lines including the discontinuous line in the example in FIG. 23 described above. In the example in FIG. 38, in the line-shaped object 541, a first part 770 indicated by a thin solid line (a thin continuous line) corresponds to a part in which the reproduction of the video 530 is not yet finished. In the line-shaped object 541, a second part 771 indicated by a solid line thicker than that of the first part 770 corresponds to a part in which the reproduction of the video 530 is finished. In the line-shaped object 541, a third part 772 indicated by a dotted line which is a type of the discontinuous line corresponds to first information that the predetermined type of value regarding the reproduced part is equal to or larger than the first predetermined value and also corresponds to a part in which the reproduction of the video 530 is finished. In the line-shaped object 541, a fourth part 773 indicated by an alternate long and short dash line which is a type of the discontinuous line corresponds to second information that the predetermined type of value regarding the reproduced part is equal to or smaller than the second predetermined value and a part in which the reproduction of the video 530 is not yet finished. In the example in FIG. 38, the fourth part 773 is indicated by the thicker line than that of the first part 770, however, the thicknesses of the fourth part 773 and the first part 770 may be the same as each other.

As described above, if the line-shaped object 541 is indicated by the plural types of lines, the second reproduction supplemental information according to the reproduced part is indicated by the type of line in a part where the slider 542 whose position indicates the reproduced part is located. If the line-shaped object 841 is indicated by the plural types of lines, the third shooting supplemental information according to the shooting frame image is indicated by the type of line in a part of the line-shaped object 841 corresponding to the shooting frame image.

Although the electronic apparatus 1 reproduces the video which is taken with the electronic apparatus 1 itself in the example described above, the electronic apparatus 1 may reproduce the video which is taken with a photographing device different from the electronic apparatus 1. Although the electronic apparatus 1 acquires the first and second reproduction supplemental information and the first to third shooting supplemental information by itself, a device different from the electronic apparatus 1 may acquire the first and second reproduction supplemental information and the first to third shooting supplemental information.

Although the electronic apparatus 1 is a mobile phone, such as a smartphone, in the above-mentioned examples, the electronic apparatus 1 may be the other types of electronic apparatuses. The electronic apparatus 1 may be a tablet terminal, a personal computer, and a wearable apparatus, for example.

While the electronic apparatus 1 has been described above in detail, the above description is in all aspects illustrative and not restrictive. The various modifications described above are applicable in combination as long as they are not mutually inconsistent. It is understood that numerous modifications which have not been exemplified can be devised without departing from the scope of the present disclosure.

1. An electronic apparatus, comprising
a display configured to reproduce a video and display a seek bar in which a slider moves on a line-shaped object in accordance with progress of a reproduction of the video and a position of the slider on the line-shaped object indicates a reproduced part of the video, wherein
the line-Shaped object has a curved shape in accordance with first information according to the reproduced part, and
the position of the slider indicates the reproduced part and the first information according to the reproduced part.

2. The electronic apparatus according to claim 1, wherein
the line-shaped object is expressed in a two-dimensional graph in which a first axis indicates an elapsed time for a reproduction of the video, and a second axis indicates the first information.

3. The electronic apparatus according to claim 2, wherein
the first information according to the reproduced part includes one of an altitude and atmospheric pressure of a shooting position of an image in the reproduced part at a time of taking the image.

4. The electronic apparatus according to claim 2, wherein
the first information according to the reproduced part includes one of a speed of a photographing device which takes the video when the photographing device takes an image in the reproduced part, a temperature of the photographing device when the photographing device takes the image, and a distance of the photographing device moving from a position of starting taking the video to a position of taking the image.

5. The electronic apparatus according to claim 2, wherein
the first information according to the reproduced part includes information whether or not an event occurs at a time of taking an image in the reproduced part.

6. The electronic apparatus according to claim 2, comprising
at least one processor configured to control a display of the display, wherein
the at least one processor changes a height of the line-shaped object along the second axis in accordance with an operation of a user on the line-shaped object along the second axis.

7. The electronic apparatus according to claim 1, wherein
the line-shaped object has a curved shape in accordance with a route along which a photographing device taking the video moves while taking the video, and
the first information according to the reproduced part indicates a position of the photographing device on the route when the photographing device takes an image in the reproduced part.

8. The electronic apparatus according to claim 7, wherein
the slider indicates a direction in which a lens of a camera of the photographing device faces at a time of taking an image in the reproduced part indicated by the position of the slider.

9. The electronic apparatus according to claim 7, wherein
the display displays the seek bar on a map so that the line-shaped object coincides with the route on the map.

10. The electronic apparatus according to claim 9, wherein
a display mode of the display includes:
a first display mode of displaying the seek bar on the map so that the line-shaped object coincides with the route on the map; and
a second display mode of displaying the seek bar without displaying the map, and displaying the video to be larger than that in the first display mode.

11. The electronic apparatus according to claim 1, wherein
the line-shaped object is indicated by plural types of lines in accordance with second information according to the reproduced part,
the second information according to the reproduced part is other than information indicating whether or not the reproduced part has been reproduced, and
the second information according to the reproduced part is indicated by a type of a line in a part where the slider whose position in the line-shaped object indicates the reproduced part is located.

12. The electronic apparatus according to claim 11, wherein
colors of the plural types of lines are different from each other.

13-14. (canceled)

15. The electronic apparatus according to claim 11, wherein
the second information according to the reproduced part is information indicating that a certain value regarding the reproduced part falls within a predetermined range.

16. The electronic apparatus according to claim 15, wherein
the certain value regarding the reproduced part indicates one of an altitude and atmospheric pressure in a position where an image in the reproduced part is taken at a time of taking the image or one of a speed and temperature of a photographing device which takes the video at the time of taking the image.

17. The electronic apparatus according to claim 11, wherein
the second information according to the reproduced part is information that an event occurs at a time of taking an image in the reproduced part.

18. The electronic apparatus according to claim 1, wherein
the first information is acquired during a shooting of the video.

19. The electronic apparatus according to claim 11, wherein
the first information and the second information are acquired during a shooting of the video.

20. The electronic apparatus according to claim 1, further comprising
a camera configured to take the video.

21. (canceled)

22. A computer-readable non-transitory recording medium storing a control program for controlling an electronic apparatus reproducing a video, wherein
the control program makes the electronic apparatus reproduce the video and display a seek bar in which a slider moves on a line-shaped object in accordance with progress of a reproduction of the video and a position of the slider on the line-shaped object indicates a reproduced part of the video,
the line-shaped object has a curved shape in accordance with information according to the reproduced part, and
the position of the slider indicates the reproduced part and the information according to the reproduced part.

23. A method of displaying an electronic apparatus, comprising:
reproducing a video and displaying a seek bar in which a slider moves on a line-shaped object in accordance with progress of a reproduction of the video and a position of the slider on the line-shaped object indicates a reproduced part of the video, wherein
the line-shaped object has a curved shape in accordance with information according to the reproduced part, and
the position of the slider indicates the reproduced part and the information according to the reproduced part.
